(19) United States
(12) Patent Application Publication
(10) Pub. No.: US 2022/0076159 A1
(43) Pub. Date: Mar. 10, 2022

(54) ENTITY MODIFICATION OF MODELS

(71) Applicant: National Technology & Engineering Solutions of Sandia, LLC, Albuquerque, NM (US)

(72) Inventors: Steven J. Owen, San Diego, CA (US); Timothy Shead, Albuquerque, NM (US); Shawn Martin, Sandia Park, NM (US); Armida J. Carbajal, Albuquerque, NM (US)

(21) Appl. No.: 17/016,543

(22) Filed: Sep. 10, 2020

(51) Int. Cl. G06N 20/00; G06F 3/0482; G06F 3/0484

(52) U.S. Cl. CPC G06N 20/00; G06F 3/04847; G06F 3/0482

(57) ABSTRACT

A method, apparatus, system, and computer program product for generating information for modifying a model. Training data comprising entities, operations for the entities, and a number of mesh quality metrics for meshes generated from modified entities resulting from the operations being performed on the entities are selected by a computer system. A set of machine learning models is trained by the computer system using the training data. The set of machine learning models trained with the training data identifies a number of mesh quality metrics for a set of input entities in a model input into the set of machine learning models.

### STATEMENT OF GOVERNMENT INTEREST

This invention was made with Government support under Contract No. DE-NA0003525 awarded by the United States Department of Energy/National Nuclear Security Administration. The U.S. Government has certain rights in the invention.

### BACKGROUND

### 1. Field

The present disclosure relates generally to an improved computer system and, more specifically, to modifying entities from a computer-aided design model for simulation. Still more particularly, the present disclosure provides a method, apparatus, system, and computer program product for modifying entities in a model for meshing to perform simulations for an object.

### 2. Description of the Related Art

In designing structures, models of the structures including assemblies and subassemblies are created. These models are data such as computer-aided design (CAD) models. Computer-aided design models offer numerous advantages. For instance, computer-aided design models allow engineers to visualize objects that they are designing. These models can be created using manufacturing specifications.

These computer-aided design models can be used to create models for analysis such as a finite element analysis (FEA) model. However, in analyzing a design, CAD models developed using factory specifications are not directly useful in the analysis. For example, a computer-aided design model for a structure may contain artifacts for details that have little or no effect on the outcome of a simulation of loads applied to a structure, such as fittings, bolts, gears, and other assemblies or objects. These artifacts, however, add to the complexity of the mesh generated for a model used to perform the simulations.

Therefore, it would be desirable to have a method and apparatus that take into account at least some of the issues discussed above, as well as other possible issues. For example, it would be desirable to have a method and apparatus that overcome a technical problem with increased use of processing resources needed to perform simulations using meshes generated from models containing artifacts.

### SUMMARY

According to one embodiment of the present invention, a model modification system comprises a computer system and a model manager in the computer system. The model manager is configured to select training data comprising entities, operations for the entities, and a number of mesh quality metrics for meshes generated from modified entities resulting from the operations being performed on the entities. The model manager is configured to train a set of machine learning models using the training data, wherein the set of machine learning models trained with the training data identifies the number of mesh quality metrics for a set of input entities in a model input into the set of machine learning models.

According to another embodiment of the present invention, a model modification system comprises a computer system and a set of machine learning models in the computer system. The set of machine learning models is trained using training data comprising entities, operations for the entities, and quality metrics for modified entities after the operations are performed on the entities. The set of machine learning models identifies a number of quality metrics for a set of input entities input into the set of machine learning models.

According to yet another embodiment of the present invention, a method modifies a model. Training data comprising entities, operations for the entities, and a number of mesh quality metrics for meshes generated from modified entities resulting from the operations being performed on the entities are selected by a computer system. A set of machine learning models is trained by the computer system using the training data. The set of machine learning models trained with the training data identifies a number of mesh quality metrics for a set of input entities in a model input into the set of machine learning models.

According to still another embodiment of the present invention, a computer program product for modifying a model comprises a computer-readable storage media with first program code and second program code stored on the computer-readable storage media. The first program code is executable by a computer system to cause the computer system to select training data comprising entities, operations for the entities, and a number of mesh quality metrics for meshes generated from modified entities resulting from the operations being performed on the entities. The second program code is executable by the computer system to cause the computer system to train a set of machine learning models using the training data. The set of machine learning models trained with the training data identifies the number of mesh quality metrics for a set of input entities in a model input into the set of machine learning models.

### BRIEF DESCRIPTION OF THE DRAWINGS

FIG. 1 is a pictorial representation of a network of data processing systems in which illustrative embodiments may be implemented;

FIG. 2 is a block diagram of a model environment in accordance with an illustrative embodiment;

FIG. 3 is an illustration of training data generation in accordance with an illustrative embodiment;

FIG. 4 is an illustration of machine learning models that determine values for mesh quality metrics in accordance with an illustrative embodiment;

FIG. 5 is a model manager performing a modification operation on an entity in accordance with an illustrative embodiment;

FIG. 6 is a table of operations that can be performed to modify a geometry of entities in accordance with an illustrative embodiment;

FIG. 7 is a table of features in accordance with an illustrative embodiment;

FIG. 8 is an entity in accordance with an illustrative embodiment;

FIG. 9 is a modified entity in accordance with an illustrative embodiment;

FIG. 10 is a mesh from an unmodified entity in accordance with an illustrative embodiment;

FIG. 11 is a mesh from an modified entity in accordance with an illustrative embodiment;

FIG. 12 is an illustration of a mesh quality metric in a form of a scaled Jacobian before a modification operation in accordance with an illustrative embodiment;

FIG. 13 is an illustration of a mesh quality metric in a form of a scaled Jacobian after a modification operation in accordance with an illustrative embodiment;

FIG. 14 is an illustration of a mesh quality metric in a form of a scaled in-radius before a modification operation in accordance with an illustrative embodiment;

FIG. 15 is an illustration of a mesh quality metric in a form of a scaled in-radius after a modification operation in accordance with an illustrative embodiment;

FIG. 16 is a graphical user interface modifying input entities in a model in accordance with an illustrative embodiment;

FIG. 17 is a flowchart of a process for training machine learning models in accordance with an illustrative embodiment;

FIG. 18 is another flowchart of a process for training machine learning models in accordance with an illustrative embodiment;

FIG. 19 is a flowchart of a process for generating training data in accordance with an illustrative embodiment;

FIG. 20 is a flowchart of a process for determining mesh quality metrics for modified entities in accordance with an illustrative embodiment;

FIG. 21 is a flowchart of a process for obtaining mesh quality metrics for entities in a model in accordance with an illustrative embodiment;

FIG. 22 is a flowchart of a process for performing a modification operation in accordance with an illustrative embodiment;

FIG. 23 is a flowchart of a process for performing a modification operation with user input in accordance with an illustrative embodiment;

FIG. 24 is a flowchart of a process for performing a modification operation with user input in accordance with an illustrative embodiment;

FIG. 25 is a flowchart of a process for displaying modification operations for a set of input entities on a graphical user interface in accordance with an illustrative embodiment;

FIG. 26 is a flowchart of a process for performing a modification operation in accordance with an illustrative embodiment;

FIG. 27 is a process for performing a modification operation in accordance with an illustrative embodiment;

FIGS. 28A-28B are a flowchart of a process for generating training data of a CAD defeaturing model in accordance with an illustrative embodiment;

FIG. 29 is a block diagram of a data processing system in accordance with an illustrative embodiment;

FIG. 30 is a table of results from performing operations on entities in CAD part models in accordance with an illustrative embodiment;

FIG. 31 is a bar graph illustrating success of meshing operations in accordance with an illustrative embodiment;

FIG. 32 is a bar graph illustrating precision scores for machine learning models in accordance with an illustrative embodiment;

FIG. 33 is a bar graph illustrating recall scores for failure prediction models trained in accordance with an illustrative embodiment;

FIG. 34 is a bar graph of mean absolute error across mesh quality metrics in accordance with an illustrative embodiment;

FIG. 35 is a bar graph illustrating mesh quality metrics in a form of a scaled Jacobian in accordance with an illustrative embodiment;

FIG. 36 is a bar graph illustrating mesh quality metrics in a form of an in-radius in accordance with an illustrative embodiment;

FIG. 37 is a bar graph illustrating mesh quality metrics in a form of a deviation in accordance with an illustrative embodiment; and

FIG. 38 is a table of feature vectors in accordance with an illustrative embodiment.

### DETAILED DESCRIPTION

The illustrative embodiments recognize and take into account one or more different considerations. For example, the illustrative embodiments recognize and take into account that currently used techniques for generating models based on manufacturing specifications are not directly useful for structural analysis. The illustrative embodiments recognize and take into account that a model may contain geometric entities that do not affect or have a negligible effect on simulation results. These types of geometric entities are artifacts. Further, geometric entities can be referred to just as entities. The illustrative embodiments recognize and take into account that these artifacts increase the use of resources needed to perform simulations and can increase simulation time in which meshes containing these artifacts have unnecessary complexity.

The illustrative embodiments also recognize and take into account that removing entities in a computer-aided design (CAD) model of an object can eliminate entities that may be required for accurately simulating an object when generating a mesh from the computer-aided design model to form a model for use in simulating the object.

The illustrative embodiments also recognize and take into account that entities in a computer-aided design model of an object can be selectively modified by an expert user who can identify entities that are problematic. The illustrative embodiments recognize and take into account, however, an expert should have sound engineering judgment based on knowledge of the physics to be simulated, an understanding of the next-generation procedure, and the expected mesh quality outcomes to make adjustments. The illustrative embodiments also recognize and take into account that this process may be complex and time-consuming when performed by an expert to modify entities in a manner that reduces the risk of eliminating entities required for a simulation. The illustrative embodiments recognize and take account that it would be desirable to reduce the time and effort needed to modify the entities in the computer-aided design model of the object. The illustrative embodiments also recognize and take into account that it would be desirable to permit users who are not experts to modify the entities in the computer-aided design model prior to generating a mesh from the computer-aided design model for use in simulations of the object.

For example, the illustrative embodiments recognize and take into account that it would be desirable to have a model modification system configured to predict which entities will lead to undesired local mesh quality and present these entities to a user in a prioritized order. The illustrative embodiments also recognize and take into account that it would be desirable for the model modification system to present a set of suggested solutions for each entity identified as leading to an undesired local mesh quality. The illustrative embodiments recognize and take into account that it would be desirable to present the solutions in an order sorted based on their predicted ability to improve the local mesh quality.

Thus, the illustrative embodiments provide a method, apparatus, system, and computer program product for modifying a model. In this illustrative example, a model can be a computer-aided design model managed by a model modification system comprising a computer system and a model manager. The model manager is configured to select training data comprising entities, operations for the entities, and mesh quality metrics for meshes generated from modified entities resulting from the operations being performed on the entities. The model manager is also configured to train a set of machine learning models using the training data. The set of machine learning models trained with the training data identifies a number of mesh quality metrics for a set of input entities in a model input into the set of machine learning models.

As used herein, a “set of,” when used with reference to items, means one or more items. For example, a “set of machine learning models” is one or more machine learning models.

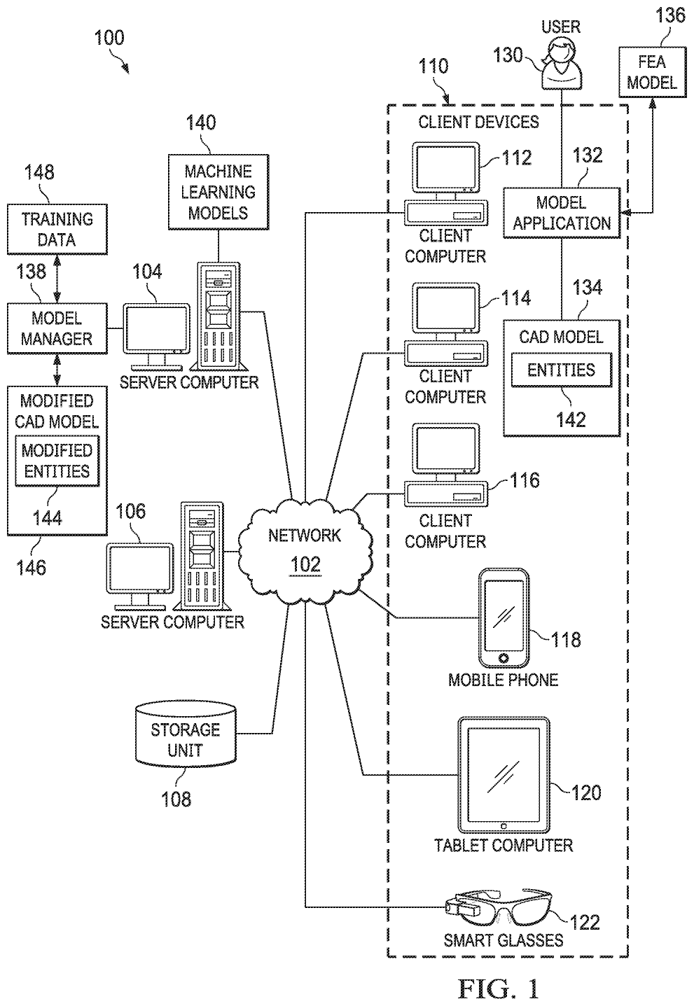

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet-of-things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage media and downloaded to a data processing system or other device for use. For example, program code can be stored on a computer-recordable storage media on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, a “number of,” when used with reference to items, means one or more items. For example, a “number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In this illustrative example, user 130 can operate model application 132 on client computer 112 to generate a design of an object in the form of computer-aided design (CAD) model 134. The object is a physical object and can be, for example, a vehicle, an engine housing, an aircraft, a skin panel, a door, awing, a fastener, or some other suitable type of object.

In this illustrative example, CAD model 134 comprises information describing the object and can be displayed in model application 132 to provide a visualization of the object on client computer 112 to user 130. The information can include, for example, dimensions, materials, processes for manufacturing the object, or other suitable information.

In this example, model application 132 can be a computer-aided design application. Model application 132 can also include other functions in addition to or in place of processes for generating a design of an object.

For example, model application 132 can also include simulation processes for simulating an application of forces on the object. The simulation processes in model application 132 can include finite element analysis (FEA) processes. As depicted, model application 132 can generate finite element analysis (FEA) model 136 from CAD model 134. This process includes generating a mesh for FEA model 136 from CAD model 134. This mesh identifies elements of which set of equations can be solved or simulating loads applied to the object.

However, performing a simulation with FEA model 136 generated from CAD model 134 may use more processing resources than desired. For example, the complexity of a mesh generated from CAD model 134 for FEA model 136 may have a complexity that increases the processing resources needed to perform the simulation to an undesirable level.

In this illustrative example, model manager 138 can use a set of machine learning models 140 to reduce the processing resources needed to perform a simulation of the object. For example, model manager 138 can modify a set of entities 142 in CAD model 134 in a manner that reduces the processing resources needed to perform a simulation. In this illustrative example, the selection of the set of entities 142 for modification is made in a manner that does not affect the accuracy of the simulation in an undesired manner. The set of entities 142 in CAD model 134 is modified to form a set of modified entities 144 in modified CAD model 146. Modified CAD model 146 can be used to generate FEA. model 136 for use in performing a simulation of the object.

As depicted, the set of machine learning models 140 is trained by model manager 138 using training data 148. In this illustrative example, training data 148 is selected to train a set of machine learning models 140 in a manner that enables machine learning models 140 to generate output that can be used to select one or more of entities 142 for modification in a manner that reduces the processing resources needed to perform a simulation while maintaining a desired level of accuracy in the simulation. The processing resources can include at least one of processor resources, time, stored space, bandwidth, or other resources used to process data. In this illustrative example, training data 148 includes entities 142, operations for entities 142, and mesh quality metrics from a mesh generated from modified entities 144 resulting from the operations being performed on the entities.

After training, model manager 138 can input CAD model 134 into the set of machine learning models 140 and receive an output that can be used to determine which entities in entities 142 should be modified to form the set of modified entities 144 for modified CAD model 146 for use in generating FEA model 136 to perform simulations of the object.

The illustrative example implemented in network data processing system 100 is only meant as an example of one manner in which components can be implemented and not meant to limit other illustrative examples. For example, model application 132 and model manager 138 can be located in the same computer rather than on separate computers as depicted in this illustration. In other illustrative examples, a simulation can be performed by another application or process on yet another computer in addition to or in place of model application 132 in client computer 112.

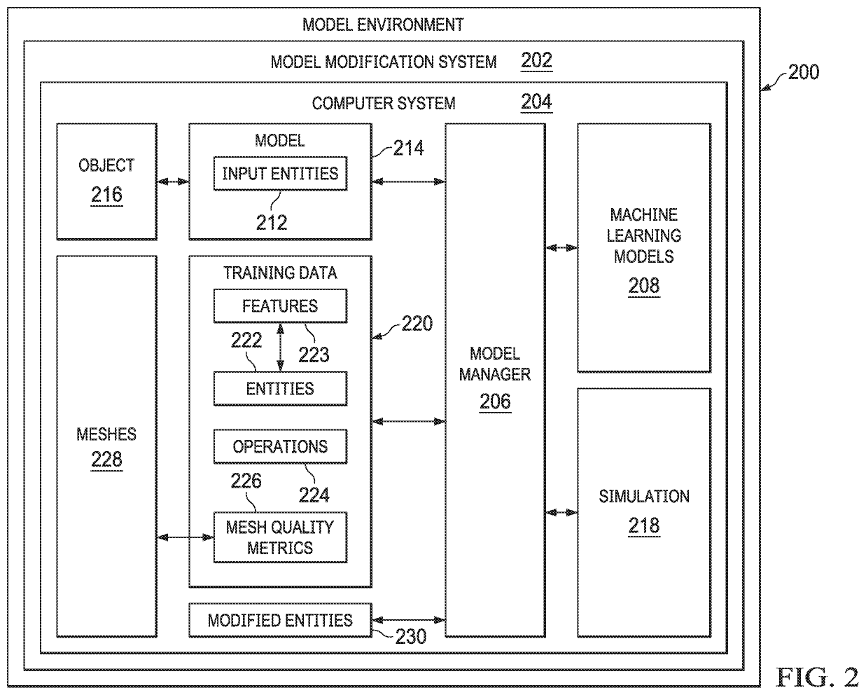

With reference now to FIG. 2, a block diagram of a model environment is depicted in accordance with an illustrative embodiment. In this illustrative example, model environment 200 includes components that can be implemented in hardware such as the hardware shown in network data processing system 100 in FIG. 1.

In this illustrative example, model modification system 202 in model environment 200 comprises computer system 204 and model manager 206 located in computer system 204. Model modification system 202 operates to train a set of machine learning models 208 to predict which input entities 212 in model 214 of object 216 can be modified to improve the performance in performing simulation 218 of object 216.

Model manager 206 can be implemented in software, hardware, firmware, or a combination thereof. When software is used, the operations performed by model manager 206 can be implemented in program code configured to run on hardware, such as a processor unit. When firmware is used, the operations performed by model manager 206 can be implemented in program code and data and stored in persistent memory to run on a processor unit. When hardware is employed, the hardware may include circuits that operate to perform the operations in model manager 206.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, model manager 206 selects training data 220 for use in training the set of machine learning models 208. In this illustrative example, training data 220 comprises entities 222, operations 224 for entities 222, and a number of mesh quality metrics 226 for meshes 228 generated from modified entities 230 resulting from operations 224 being performed on entities 222.

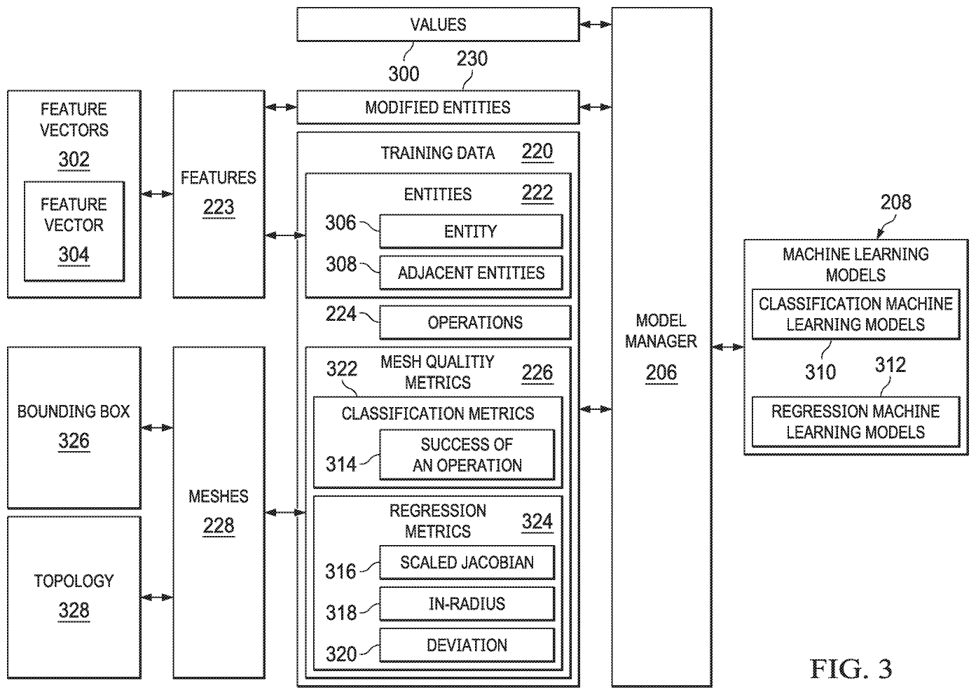

In this illustrative example, entities 222 are geometric components that are arranged in model 214 to form object 216. Entities 222 can be selected from at least one of a vertex, a curve, a line, a surface, a parametric surface, or some other geometric component. As depicted, entities 222 have features 223, which can also be referred to as geometric features. A feature in features 223 is a characteristic or attribute of an entity. Feature vectors 302 in FIG. 3 are one manner in which features 223 can be represented for a particular entity. Feature vectors 302 are data structures in which values are placed into the data structure for different features in features 223.

In the illustrative example, features 223 can be selected from at least one of an expert feature, a geometric feature, or some other type of feature. An expert feature characterizes an entity based on a fixed-length set of numerical values describing an entity and its relationships with its neighboring entities. A geometric feature can be a geometry selected from at least one of a surflet, a curvelet, or some other suitable type of geometric feature.

Operations 224 can modify entities 222 in a number of different ways. For example, a modification can change the geometry of the entity or remove the entity from model 214. The modification of an intensity can also result in the modification of adjacent entities or entities 222 sufficiently close to the entity being modified.

In changing the geometry of the entity, one or more features or components making up the entity can be changed or removed. For example, a curve can be flattened. As another example, an entity in the form of a cone can be removed. Operations 224 can be selected from at least one of remove an entity, combine entities, modify an entity, remove an entity replacement, remove a surface, tweak replace surface, composite surfaces, collapse curve, virtual collapse curve, tweak remove topology curve, tweak remove topology surface, blunt tangency, or remove cone.

In this illustrative example, model manager 206 trains the set of machine learning models 208 using training data 220. The set of machine learning models 208 trained with training data 220 identifies a number of mesh quality metrics 226 for a set of input entities 212 in model 214 input into the set of machine learning models 208. In this illustrative example, a machine learning model in the set of machine learning models 208 can be trained to output predicted mesh quality metrics for an operation in operations 224 for input entities 212. These metrics can be used to determine whether an operation should be performed to modify one or more of entities 222 in model 214. In the illustrative example, mesh quality metrics 226 output by the set of machine learning models 208 occur without generating meshes 228 for model 214.

With reference next to FIG. 3, an illustration of training data generation is depicted in accordance with an illustrative embodiment. In the illustrative examples, the same reference numeral may be used in more than one figure. This reuse of a reference numeral in different figures represents the same element in the different figures.

In this illustrative example, model manager 206 can generate training data 220 used to train the set of machine learning models 208. For example, in generating training data 220, model manager 206 can identify entities 222 and identify operations 224 for entities 222. In this illustrative example, model manager 206 can perform operations 224 on entities 222 to form modified entities 230 and determine a set of values 300 for a number of mesh quality metrics 226 for meshes 228 generated from modified entities 230. In this illustrative example, entities 222 can be identified in one or more models by model manager 206. Not all entities in a model need to be used in selecting or identifying entities 222.

In determining the set of values 300 for the number of mesh quality metrics 226 for meshes 228 generated from modified entities 230, model manager 206 can determine the set of values 300 for the number of mesh quality metrics 226 for meshes 228 generated using feature vectors 302 quantifying features 223 in modified entities 230.

In this illustrative example, entities 222 and modified entities 230 are described by feature vectors 302. Feature vectors 302 can be selected from at least one of a curve length, a surface area, an angle at a vertex, an angle at a curve, a valence at a vertex, a number of loops, a hydraulic radius, or some other type of feature.

As depicted, model manager 206 can perform operations 224 in a number of different ways. For example, model manager 206 can determine feature vectors 302 for entities 222. In this illustrative example, feature vector 304 in feature vectors 302 describes entity 306 in entities 222 and a relationship of entity 306 with a set of adjacent entities 308 in entities 222.

Feature vectors 302 can be used to determine values 300 for mesh quality metrics 226 for training data 220. Values 300 for mesh quality metrics 226 can be determined before and after the performance of operations 224 on entities 222 in generating training data 220. In other words, some of the values in values 300 for mesh quality metrics 226 for training data 220 are “no-op values” determined for entities 222 while other values in values 300 for training data 220 are “op values” determined for modified entities 230.

In this illustrative example, the set of mesh quality metrics 226 can take different forms. For example, the set of mesh quality metrics 226 can be at least one of success of an operation 314. scaled Jacobian 316, in-radius 318, deviation 320, or some other suitable metric that can be used to determine the quality of an entity. Mesh quality metrics 226 also include ground truth output data for training data 220.

The ground truth can involve generating a tetrahedral mesh and evaluating the local mesh quality to generate mesh quality metrics for each entity without performing an operation on the entity. A mesh can be generated after the performance of an operation, and mesh quality metrics 226 can be generated for each entity to provide a ground truth for mesh quality metrics 226 resulting from performing the operations.

In the illustrative example, classification metrics 322 are used to indicate success of an operation 314. Success of an operation 314 is a classification metric that is a result of a determination of whether an operation is successful or not when attempting to generate a mesh using an entity. The values for this metric can be, for example, true or false or a binary value such as 1 or 0 to indicate whether a mesh can be generated for the modified entity. The classification can be used to determine whether a particular operation for a particular modified entity should be processed to obtain one or more of regression metrics 324. This information is useful for identifying and eliminating operations that would not be effective for modifying entities.

In this illustrative example, scaled Jacobian 316, in-radius 318, and deviation 320 are regression metrics 324. In this example, scaled Jacobian 316 is the minimum Jacobian at any of the four vertices of a tetrahedron divided by the lengths of its three adjacent edges. The tetrahedron is a tetrahedron in the mesh from which this metric is determined. As depicted, a value of 1 for scaled Jacobian 316 represents a perfectly shaped equilateral tetrahedra, while a value of less than 0 defines an inverted element. In this example, scaled Jacobian 316 can be used as a ground truth and is independent of mesh size and is representative of the Jacobian mapping function used in finite element analysis processes.

As depicted, in-radius (Mᵢᵣ) 318 is the radius of an inscribed sphere within a tetrahedra. This value is an absolute distance and in-radius 318 is a scaled in-radius value (Mₛᵢᵣ) when in-radius 318 is the in-radius of an equilateral tetrahedra in the mesh with an edge length equal to a target mesh size. In-radius 318 with a value of 1 represents a perfectly sized element, while in-radius 318 with a value that is less than 1 is smaller than the mesh size. In-radius 318 with a value greater than 1 is larger than the mesh size. For training purposes, data can be generated using multiple target mesh sizes. In-radius 318 can be a ground truth to determine how to avoid small elements that may result in long run-times for finite element analysis processes.

Deviation (M_{sd}) 320 is the distance from the centroid of a surface triangle to its closest point on the geometry of the entity. Unlike scaled Jacobian 316 and in-radius 318 that describe characteristics of a tetrahedra, deviation 320 is a triangle metric that can measure how closely the boundary of the mesh conforms to the prescribed geometry for an entity.

For this metric, a scaled deviation (M_{sd}) is equal to M_{sd}/ST. A value of 0 for deviation 320 represents a triangle that perfectly matches the geometry for the entity. Values of deviation 320 greater than 0 are necessary for any geometry with a curvature in this example. Minimizing deviation 320 is beneficial to ensure the mesh adequately represents the input geometry of the entity. In this case, a maximum value for deviation 320 defines the worst quality for the entity.

In this illustrative example, a set of values 300 for the number of mesh quality metrics 226 for meshes 228 generated from modified entities 230 can take a number of different forms. For example, the set of values 300 can be at least one of an actual value for mesh quality metrics 226 or a difference between the value of a mesh quality metric before and after an operation. Further, the set of values 300 determined for mesh quality metrics 226 are part of mesh quality metrics 226 in training data 220 used by model manager 206 to train machine learning models 208.

In this depicted example, meshes 228 used to determine mesh quality metrics 226 are described using at least one of bounding box 326, topology 328, or some other suitable methodology for identifying tetrahedra that are considered to be sufficiently close to an entity when determining the set of mesh quality metrics 226 for the entity. At least one of bounding box 326 or topology 328 can be used to include tetrahedra in meshes 228 that are sufficiently close or local to an entity in entities 222.

The tetrahedra within bounding box 326 or topology 328 can be used in determining the set of mesh quality metrics 226 for particular operations. In other words, these techniques can be used to determine the locality for the size of the mesh used to determine mesh quality metrics 226.

For example, bounding box 326 can enclose a set of tetrahedral in a mesh surrounding one or more entities involved in an operation. As another example, topology 328 is a local topology that defines the set of tetrahedral in the mesh that share at least one mesh node with the entity.

In this depicted example, entities 222, operations 224, and values 300 for the set of mesh quality metrics 226 form training data 220. With this training data, model manager 206 can train the set of machine learning models 208 to output predicted values for the number of mesh quality metrics 226 for entities 222. In this illustrative example, machine learning models 208 can be at least one of a set of classification machine learning models 310 or a set of regression machine learning models 312.

In the illustrative example, the training can be performed such that at least one machine learning model is trained to classify the particular operations to determine success or failure in classification machine learning models 310.

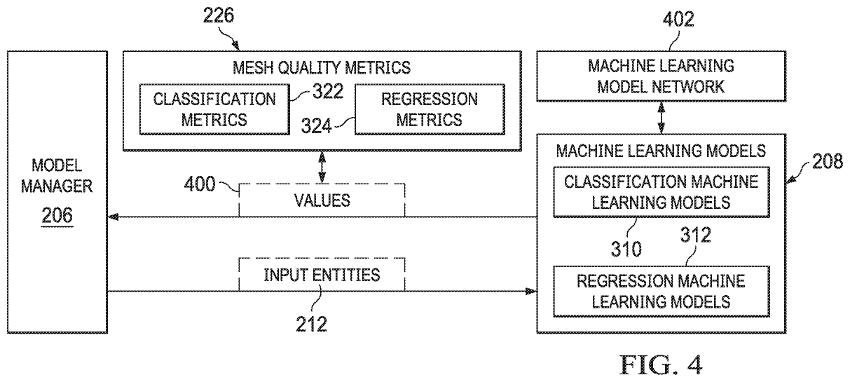

With reference next to FIG. 4, an illustration of machine learning models that determine values for mesh quality metrics is depicted in accordance with an illustrative embodiment. In this illustrative example, model manager 206 can modify input entities 212 in model 214 in FIG. 2. As depicted, model manager 206 can input model 214 in FIG. 2 with the set of input entities 212 into a set of machine learning models 208. In this example, machine learning models 208 have been trained using training data 220 in FIG. 2. Model manager 206 can receive a set of values 400 from machine learning models 208. In this example, the set of values 400 is for a number of mesh quality metrics 226 that occurs for a set of operations 224 in FIG. 2 that can be performed to modify a set of input entities 212 in model 214 input into the set of machine learning models 208.

In this illustrative example, the set of machine learning models 208 comprises a set of classification machine learning models 310 and a set of regression machine learning models 312 configured as machine learning model network 402. The set of classification machine learning models 310 receives input entities 212 in model 214 in FIG. 2 and determines values 400 for classification metrics 322 in mesh quality metrics 226. In this example, classification metrics 322, such as success of an operation 314, indicate the success or failure of an operation. This metric indicates whether an input entity can be processed to generate meshes after being modified by an operation.

Based on values 400 for regression metrics 324 in mesh quality metrics 226, model manager 206 can send input entities 212 to the set of regression machine learning models 312. These input entities are input entities 212 for which meshes can be generated for a particular operation. The set of regression machine learning models 312 can output values 400 for mesh quality metrics 226 to model manager 206 in which values 400 are regression metrics 324 in mesh quality metrics 226. These output values can be used to determine which entities in input entities 212 should be modified.

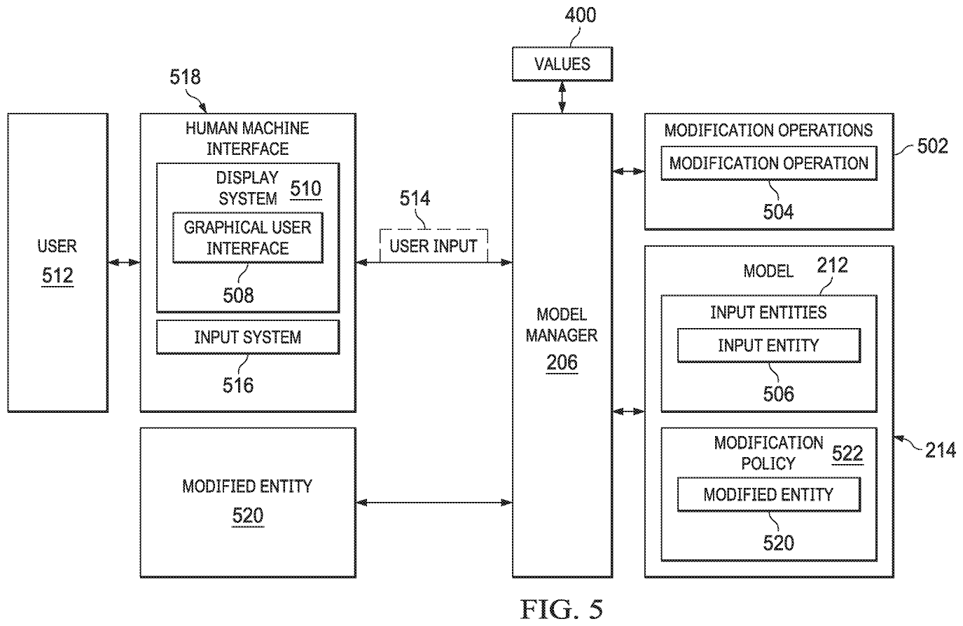

Turning to FIG. 5, an illustration of a model manager performing a modification operation on an entity is depicted in accordance with an illustrative embodiment.

With a set of values 400, model manager 206 can perform modification operations 502 in a number of different ways. For example, model manager 206 can perform modification operation 504 in modification operations 502 on input entity 506 in a set of input entities 212 in model 214 based on the set of values 400 for a number of mesh quality metrics 226 in FIG. 2 for a set of input entities 212 for model 214. In other words, modification operation 504 can be performed after receiving suggestions in the form of the set of values 400 for the number of mesh quality metrics 226. Values 400 can be scores for modification operations 502. In other illustrative examples, the suggestions can be a ranking of modification operations 502 or a suggestion of a particular modification operation in modification operations 502.

In this illustrative example, model manager 206 performs modification operation 504 based on user input 514 selecting modification operation 504. As depicted, model manager 206 can display a set of modification operations 502 for the set of input entities 212 in graphical user interface 508 displayed on display system 510. Model manager 206 can also display the set of values 400 for the number of mesh quality metrics 226 resulting from performing the set of modification operations 502 on the set of input entities 212 in graphical user interface 508 on display system 510.

As depicted, display system 510 is a physical hardware system and includes one or more display devices on which graphical user interface 508 can be displayed. The display devices can include at least one of a light emitting diode (LED) display, a liquid crystal display (LCD), an organic light emitting diode (OLED) display, a computer monitor, a projector, a flat panel display, a heads-up display (HUD) or some other suitable device that can output information for the visual presentation of information.

User 512 is a person that can interact with graphical user interface 508 through user input 514 generated by input system 516 for computer system 204 in FIG. 2. Input system 516 is a physical hardware system and can be selected from at least one of a mouse, a keyboard, a trackball, a touchscreen, a stylus, a motion sensing input device, a gesture detection device, a cyber glove, or some other suitable type of input device. Display system 510 and input system 516 form human machine interface (HMI) 518.

In this illustrative example, model manager 206 can receive user input 514 selecting modification operation 504 in the set of modification operations 502 for input entity 506 in set of input entities 212. Model manager 206 can receive user input 514 from input system 516 and perform modification operation 504 on input entity 506 in the set of input entities 212 in model 214 selected by user input 514. The performance of modification operation 502 forms modified entity 520 in model 214 in place of input entity 506.

In another illustrative example, model manager 206 can select modification operation 504 from the set of modification operations 502 for input entity 506 in the set of input entities 212 based on modification policy 522. Modification policy 522 is a set of rules and can include data to apply the rules. Modification policy 522 can include rules that indicate which ones of modification operations 502 should be performed based on particular values for the set of mesh quality metrics 226. In this illustrative example, modification policy 522 can include rules that set out a desired quality level resulting from performing an operation on an entity.

As depicted, model manager 206 can perform modification operation 504 on input entity 506 in the set of input entities 212 in model 214 selected based on applying modification policy 522 to form a set of modified entities 524. As a result, machine learning models 208 can operate to predict a mesh quality for input entities 212 in model 214. The mesh quality is described using mesh quality metrics 226. Further, user 512 can select an operation using the set of input entities 212 displayed in graphical user interface 508. In this example, the set of input entities 212 are sorted from worst-to-best quality. Further, for an input entity in input entities 212, a list of operations for the input entity can be listed along with a predicted mesh quality for each operation that can be performed on the input entity. Further, these operations for an input entity can be displayed in graphical user interface 508 sorted from best-to-worst mesh qualities.

As a result, user 512 can be presented with a prioritized list of input entities 212 from model 214 that can be modified along with operations 224 in FIG. 2 that can be performed on input entities 212 in graphical user interface 508. With model manager 206, an inexperienced user can quickly modify model 214 using a “greedy” approach by repeatedly choosing the first suggestion for every entity, while users with greater experience can follow or ignore the suggested operations. With a greedy approach, the best operation may be used at each step based on the current state of the mesh.

In one illustrative example, one or more technical solutions are present that overcome a technical problem with increased use of processing resources needed to perform simulations using meshes generated from models containing artifacts. As a result, one or more technical solutions may provide a technical effect of providing information on the quality of a mesh generated from a model when one or more entities in the model is modified. One or more technical solutions enable modifying an entity to reduce the complexity in the mesh in a manner that results in a lower use of the processing resources while maintaining a desired level of quality in a simulation. In one or more illustrative examples, machine learning models output predicted values for mesh quality metrics for modified entities modified by operations. These values can be used to determine whether a particular operation in an entity is selected to be performed on the entity.

Computer system 204 can be configured to perform at least one of the steps, operations, or actions described in the different illustrative examples using software, hardware, firmware, or a combination thereof. As a result, computer system 204 operates as a special purpose computer system in which model manager 206 in computer system 204 enables modifying a model such that a mesh generated for simulation uses less processing resources while maintaining a desired level of accuracy in the simulation. In particular, model manager 206 transforms computer system 204 into a special purpose computer system as compared to currently available general computer systems that do not have model manager 206.

In the illustrative example, the use of model manager 206 in computer system 204 integrates processes into a practical application for a method for modifying a model that increases performance of computer system 204. In other words, model manager 206 in computer system 204 is directed to a practical application of processes integrated into model manager 206 in computer system 204 that trains machine learning models to provide output that can be used to select operations performed on entities in a model such that processing resources used to perform the simulation are reduced. In other words, model manager 206 enables the generation of simulation models such as finite element analysis (FEA) models from computer-aided design (CAD) models that result in reducing the use of processing resources in computer system 204 to perform simulations as compared to current techniques.

The illustrations of model environment 200 and the different components in this environment in FIGS. 2-5 are not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, machine learning models 208 are depicted in FIG. 3 as being classification machine learning models 310 and regression machine learning models 312. In some illustrative examples, machine learning models 208 can be trained to perform both classification and regression. As another example, model manager 206 can also create models for simulations such as finite element analysis (FEA) models from models such as computer-aided design (CAD) models.

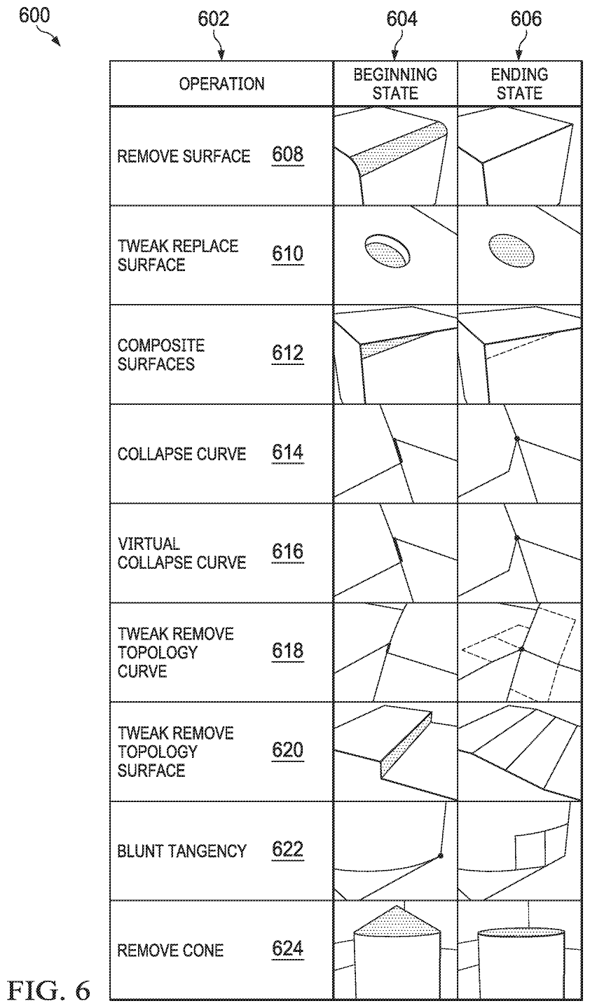

With reference now to FIG. 6, a table of operations that can be performed to modify a geometry of entities is depicted in accordance with an illustrative embodiment. In this illustrative example, table 600 illustrates examples of operations 224 in FIG. 2. As depicted, table 600 includes operation 602, beginning state 604, and ending state 606. Beginning state 604 shows an entity before performance of an operation. Ending state 606 shows a modified entity that results from performing the operation on the entity. In this illustrative example, the operations depicted in table 600 are remove surface 608, tweak replace surface 610, composite surfaces 612, collapse curve 614, virtual collapse curve 616, tweak remove topology curve 618, tweak remove topology surface 620, blunt tangency 622, and remove cone 624.

In the illustrative example, remove surface 608 is an operation that removes a surface and extends its neighboring surfaces to fill the gap left by its removal. As depicted, tweak replace surface 610 is an operation that moves a surface by a small distance by using another surface as a reference.

As depicted, composite surfaces 612 is an operation that suppresses curves between neighboring surfaces and is used to avoid elements that would be smaller than desired or having undesirable mesh quality metrics. This operation can combine two surfaces into one.

In this example, collapse curve 614 and virtual collapse curve 616 are operations that combine geometric entities by collapsing curves between two given vertices. Tweak remove topology curve 618 and tweak remove topology surface 620 are operations that redefine the local geometry and topology at a curve by removing and adding geometric entities.

In this illustrative example, blunt tangency 622 is an operation that increases an angle at a given vertex by introducing new surface patches. In the illustrative example, remove cone 624 is an operation that replaces a conical geometric surface with a flat surface.

The illustration of these operations is only presented as some limiting examples and not meant to limit the manner in which other illustrative examples can be implemented. In other illustrative examples, other types of operations can be performed in addition to or in place of the operations displayed in table 600.

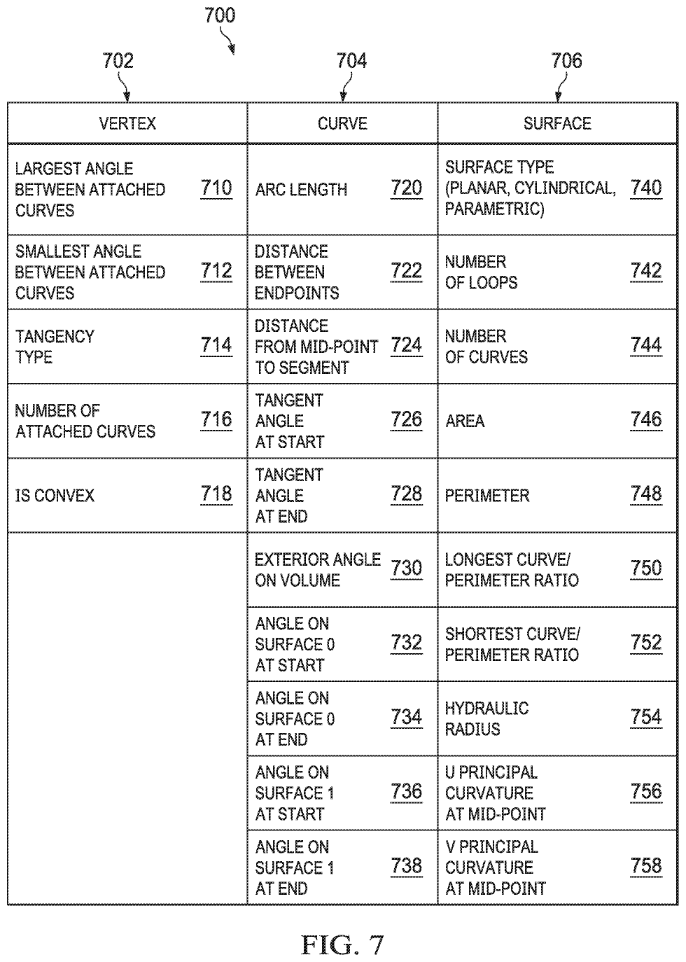

Turning to FIG. 7, a table of features is depicted in accordance with an illustrative embodiment. In this illustrative example, table 700 illustrates information about features that can be used to create feature vectors as an example implementation for feature vectors 302 in FIG. 3.

As depicted, table 700 illustrates features in the form of expert features. In this illustrative example, expert features characterize an entity based upon a fixed-length set of numerical values describing the entity and the entity's relationships with neighboring entities. In the illustrative example, a feature vector for an entity using expert features comprises an array of values based on the features described in table 700 for different types of entities.

In this depicted example, column 702 contains features used to describe an entity in the form of a vertex. Column 704 contains features that can be used to describe an entity in the form of a curve. As depicted, column 706 describes features for an entity in the form of a surface.

As depicted in this illustrative example, features for a vertex include largest angle between attached curves 710, smallest angle between attached curves 712, tangency type 714, number of attached curves 716, and is convex 718. In the illustrative example, tangency type 714 refers to how two adjacent curves intersect at a vertex. For example, two arcs or an arc and a straight segment that meet forming a tangency condition is tangency type 1. Two linear segments meeting at a vertex is tangency type 0. Convexity of a vertex refers to its context on the boundary of the computer-aided design (CAD) model. If exterior angles at adjacent curves to the vertex are less than 180 degrees, it is non-convex or convex=0. If exterior angles at adjacent curves to the vertex are greater than 180 degrees, it is convex or convex=1.

As depicted, column 704 includes features used to describe a curve. In this example, these features include arc length 720, distance between endpoints 722, distance from mid-point to segment 724, tangent angle at start 726, tangent angle at end 728, exterior angle on volume 730, angle on surface 0 at start 732, angle on surface 0 at end 734, angle on surface 1 at start 736, and angle on surface 1 at end 738.

Column 706 lists features used to describe a surface. In this example, these features include surface type 740, number of loops 742, number of curves 744, area 746, perimeter 748, longest curve/perimeter ratio 750, shortest curve/perimeter ratio 752, hydraulic radius 754, u principal curvature at mid-point 756, and v principal curvature at mid-point 758.

Number of loops 742 refers to a number of continuous sets of curves that define the boundary of the surface. For example, a circle has one loop, and an annulus has two loops. Number of loops 742 can also be defined mathematically as the genus of the surface plus one. In this example, hydraulic radius 754 is the ratio of the area (A) of the surface to its perimeter (P). Hydraulic radius 754 can be mathematically defined as HR=A/4P.

The expert features depicted for these entities in table 700 can also be used to describe operations to be performed in features. In this illustrative example, values for feature vectors for the operations can be selected from table 700 in FIG. 7. For example, the “composite” operation constructs its feature vector by including the feature values in table 700 in FIG. 7 for one curve and two surfaces where the surfaces are the two surfaces to be combined and the curve is shared between the two surfaces. Another example is the “remove_surface” operation. This operation can be described using a feature vector from five surfaces. These five surfaces are the surface to be removed and up to four adjacent surfaces ordered by their relative areas. A different combination of features is defined to construct unique feature vectors for each operation.

The illustration of expert features in table 700 for describing entities are provided for purposes of illustrating one manner in which features may be implemented. This illustration is not meant to limit the manner in which how the features may be implemented to describe the entities. For example, the features describing the entities can also take the form of geometric features. With geometric features, at least one of surflets or curvelets can be used to create vectors to describe an entity G^{R}, an operation Oₙ(G_{R}) on entity G_{R}, or both. In this example, R is an integer representing a particular entity or operation.

In one illustrative example, surflet S=(α, β, γ, δ) is a function of distance δ and angles, α, β, and γ between two points with oriented normals on a surface. Surflet pairs can be computed for any unique pair of points on the surface of a geometry. Surflet pairs can be computed from any point on the surface of the geometry near an entity or an operation to be performed on an entity. To convert an arbitrary number of surflets into a constant size vector for an entity x^{G}R, a four-dimensional histogram with dimensions defined by α, β, γ and δ is constructed. The values α, β, γ and δ for each surflet are computed and assigned to a discrete bucket [I(α), I(β), I(γ), I(δ)]. In this illustrative example, five intervals can be selected in each dimension resulting in a total of 625 unique buckets. Thus, the feature vector for the entity x^{G}R is a vector of 625 integers that records the number of surflet pairs classified within each bucket [I(α), I(β), I(γ), I(δ)].

In the illustrative example, surflet-based features include first triangulating surfaces of a computer-aided design (CAD) model to obtain a discretization. The number of points that influence the feature vector x^{G} for entity G_{R} and feature vector x^{On(G}R⁾ or an operation on entity G_{R} is limited to those points falling within a bounding box surrounding entity G_{R} or operation Oₙ^{(G}R⁾. For computational efficiency, the number of points contributing to the feature vectors x^{G}R and x^{O}ₙ^{(G}R⁾ can be limited to 1,000 when the local triangulation is dense, sampling the points at random from within the bounding box. Surflet pairs can be computed from any point on the surface of the geometry near entity G_{R} or operation Oₙ^{(G}R⁾.

With curvelets, the selection of points are points on the geometric curves that are topologically adjacent to G_{R} or Oₙ^{(G}R⁾. Instead of limiting selection to a bounding box, points on all adjacent curves at G_{R} or Oₙ^{(G}R⁾ are included. In addition, rather than using the normal vector at a point, the curvelets use the tangent vector on its associated curve. Surflets and curvelets can be used in combination or independently. In the illustrative examples, training data 220 can be generated using vectors for at least one of expert features, surflets, or curvelets.

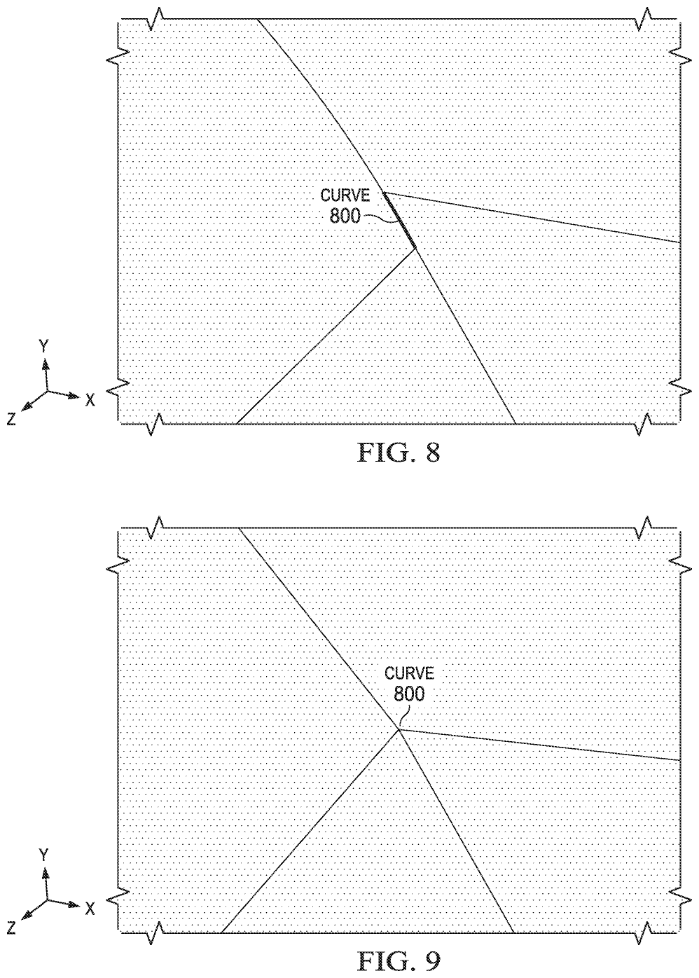

With reference next to FIG. 8, an entity is depicted in accordance with an illustrative embodiment. In this illustrative example, curve 800 is depicted. Curve 800 is small enough in this example to be a problematic entity with respect to generating a mesh for a simulation. In this example, a collapse curve operation can be formed on curve 800.

Turning to FIG. 9, a modified entity is depicted in accordance with an illustrative embodiment. In this example, curve 800 in FIG. 8 has been collapsed through the performance of a collapse curve operation.

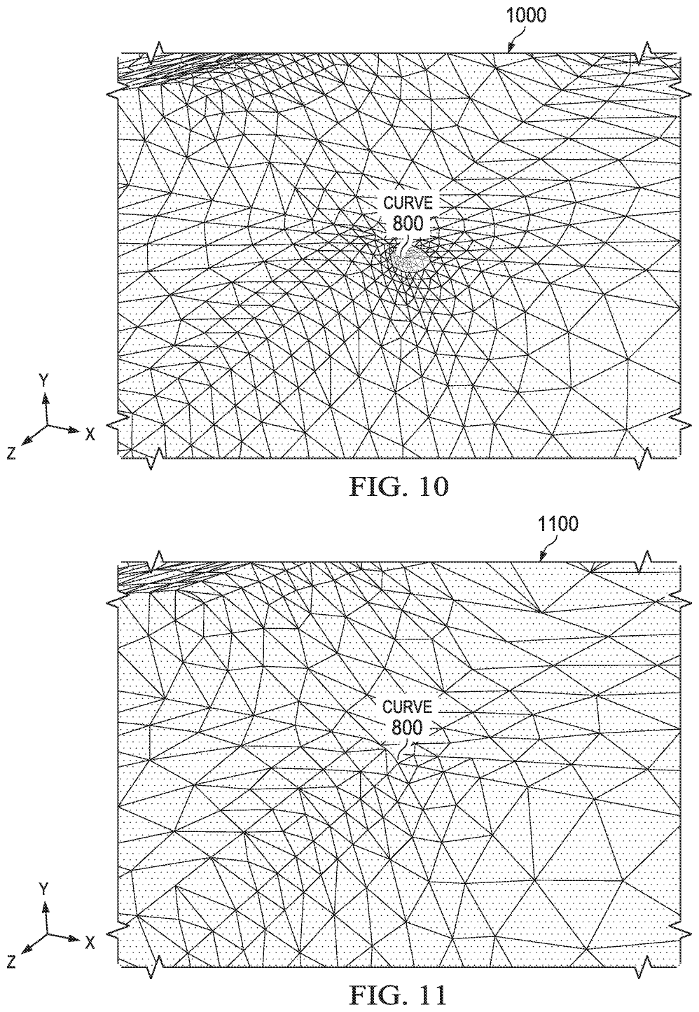

With reference now to FIG. 10, a mesh from an unmodified entity is depicted in accordance with an illustrative embodiment. In this illustrative example, mesh 1000 is generated from curve 800 as depicted in FIGS. 8-9.

With reference next to FIG. 11, a mesh from an modified entity is depicted in accordance with an illustrative embodiment. As depicted, mesh 1100 is generated from collapsing curve 800 in FIG. 9. As can be seen from FIG. 10 and FIG. 11, mesh complexity is reduced by collapsing curve 800. This modification of curve 800 results in mesh 1100, which has a lower complexity as compared to mesh 1000 in FIG. 10. As a result, the simulation performed using mesh 1100 will use less processing resources as compared to mesh 1000 in FIG. 10. In this case, collapsing curve 800 reduces mesh complexity but is intended to not affect the accuracy of the simulation in an undesired manner.

FIGS. 10 and 11 provide a visualization of how modifying entities can reduce the use of processing resources. In the illustrative example, the complexity of the mesh can be determined by calculating mesh quality metrics such as a scaled Jacobian, an in-radius, and a deviation to provide values for comparison in use in determining whether to perform an operation on an entity.

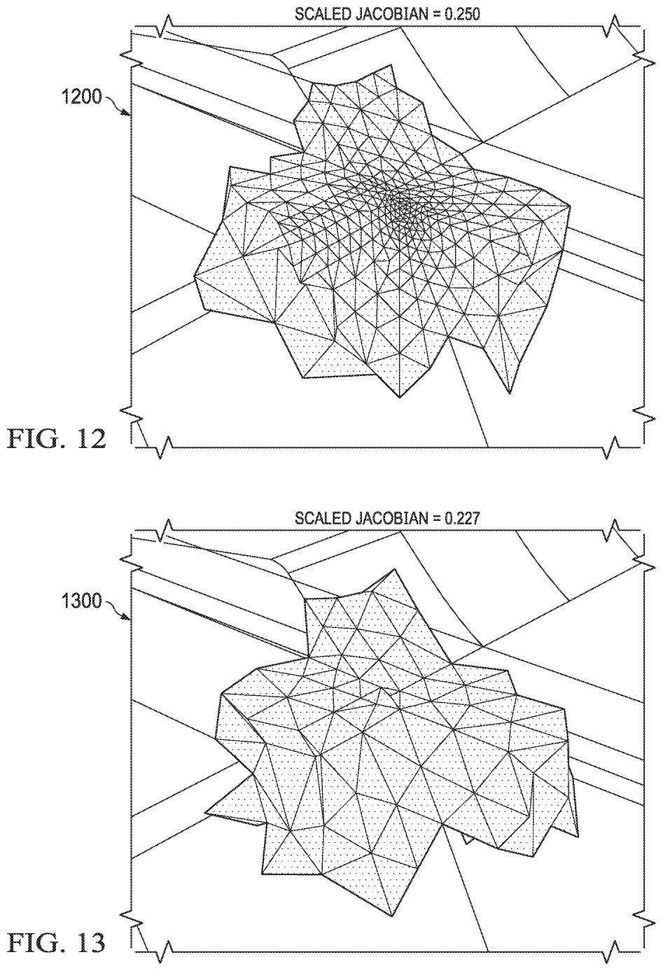

Turning now to FIG. 12, an illustration of a mesh quality metric in a form of a scaled Jacobian before a modification operation is depicted in accordance with an illustrative embodiment. In this example, mesh 1200 is created without performing a modification operation on a curve. Mesh 1200 results in a scaled Jacobian having a value of 0.250. This is the value prior to performing a modification operation in the form of a curve collapse.

Turning next to FIG. 13, an illustration of a mesh quality metric in a form of a scaled Jacobian after a modification operation is depicted in accordance with an illustrative embodiment. In this example, a collapse curve operation has been performed on the curve resulting in mesh 1300. As depicted, the value for the scaled Jacobian is 0.227 after the collapse curve operation. A desired value for a scaled Jacobian is 1 in this example. The value for the collapsed curve is smaller than prior to collapsing the curve. However, the change in value is sufficiently small as compared to the reduction in complexity of the mesh as can be seen from mesh 1200 in FIG. 12 and mesh 1300. As a result, processing resources are needed to perform a simulation with this modification of the curve. In this example, performing the collapse curve operation can result in a reduction in complexity of the mesh reducing the processing resources needed while maintaining a desired quality for the value for the scaled Jacobian.

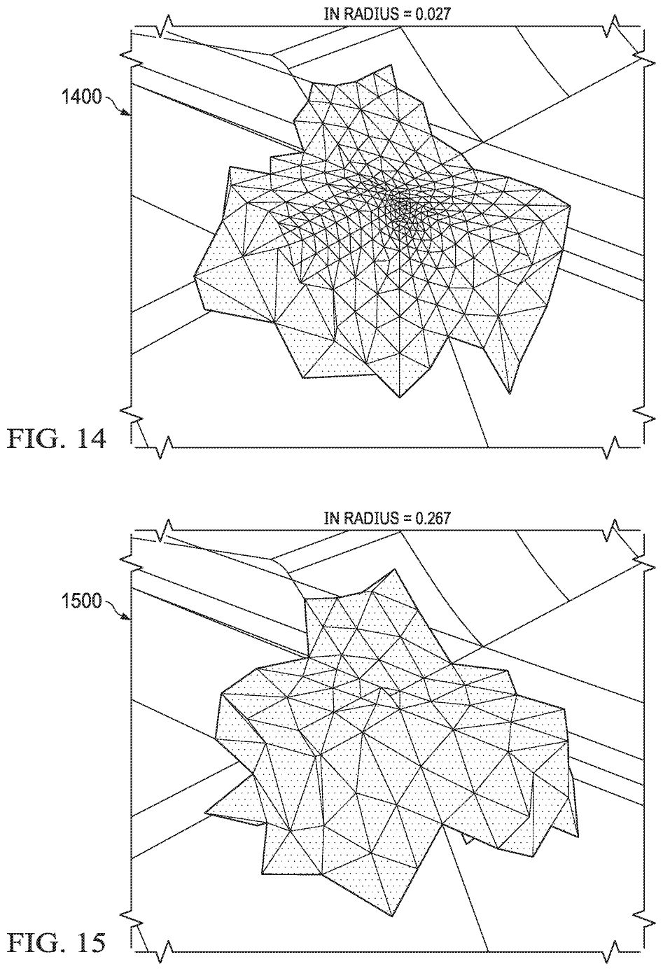

Turning now to FIG. 14, an illustration of a mesh quality metric in a form of a scaled in-radius before a modification operation is depicted in accordance with an illustrative embodiment. In this example, mesh 1400 is created without performing a modification operation on the curve. Mesh 1400 results in a mesh quality metric in the form of a scaled in-radius having a value of 0.027. This value is the value prior to performing the modification operation in the form of a curve collapse.

Turning next to FIG. 15, an illustration of a mesh quality metric in a form of a scaled in-radius after a modification operation is depicted in accordance with an illustrative embodiment. As depicted, mesh 1500 is less complex than mesh 1400 in FIG. 14. In this illustrative example, performing the modification operation to collapse the curve reduces mesh complexity resulting in less processing resources needed to perform the simulation.

In this example, collapsing the curve results in a scaled in-radius having a value of 0.267. The desired value for the mesh quality metric, in radius, is 1. The change in value is closer to the desired value. The improvement in the metric along with the reduction in the complexity of mesh 1500 after the curve collapse operation indicates that the operation is desirable with respect to this particular mesh quality metric.

As a result, a user may decide to perform the collapse curve operation after seeing the values for the mesh quality metrics such as a scaled Jacobian and an in radius. In other examples, the process may perform this operation after applying a policy.

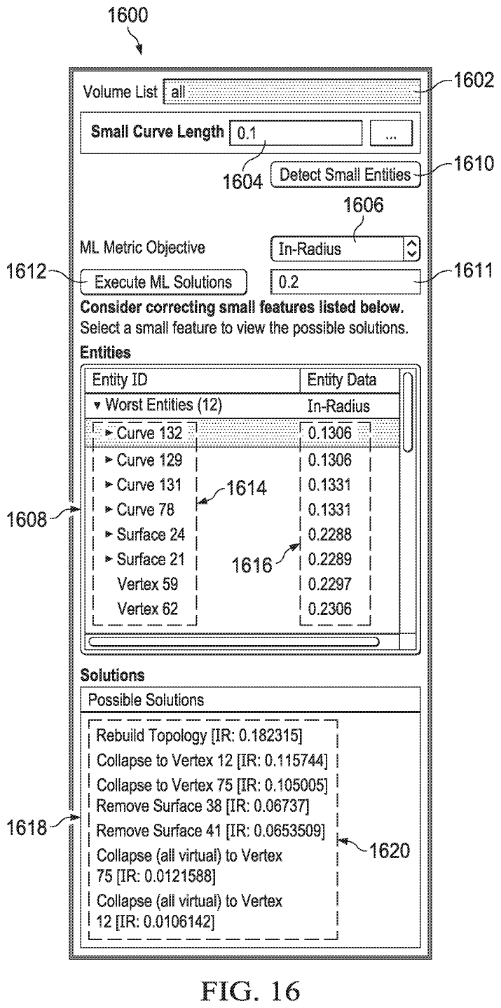

Turning next to FIG. 16, a graphical user interface modifying input entities in a model is depicted in accordance with an illustrative embodiment. In this illustrative example, graphical user interface 1600 is an example of an implementation for graphical user interface 508 displayed in display system 510 in human machine interface 518 in FIG. 5.

In this example, graphical user interface 1600 includes volume list 1602 which can be used to select volumes for entities to be modified. The entities are input entities in a model. In the illustrative example, a volume is a set of connected surfaces that close. In the illustrative example, a computer-aided design (CAD) model is composed of one or more volumes. The graphical user interface permits the user to select from the current set of volumes in volume list 1602 in the CAD model to perform diagnostics.

As depicted, size field 1604 enables a user to define a size of an entity considered small enough for modification. In this example, size field 1604 defines a curve length that is considered to be a small curve length. In this example, a user can enter a value for the small curve length. A “small surface area” can be derived as (small curve length)². In this example, hydraulic radius (HR) is also used as criteria for selecting small surfaces where HR=small_curve_length. For vertices, the smallest angle between adjacent curves is used. This angle can be set to less than 10 degrees. The user can set these values.

Control 1610 can be selected to initiate the process to detect and populate entities section 1608 in graphical user interface 1600 with entities that are considered to be small based on input to size field 1604. In this illustrative example, metric objective field 1606 enables a user to select a particular mesh quality metric. In this example, a mesh quality metric is an in-radius.

As depicted, control 1612 can be selected by the user to have the process select one or more entities for modification. In other words, selection of control 1612 can have a process such as model manager 206 in FIG. 2 select entities for modification using a policy or other mechanism. In this depicted example, limit field 1611 can be used to limit the display of predicted worse quality. In this depicted example, entities with a predicted in-radius of less than 0.2 are listed.

As depicted, entities section 1608 has been populated with entities that are small enough based on user input to size field 1604. In this example, entities section 1608 includes entity ID column 1614 and entity data column 1616. The entity ID in entity ID column 1614 is the identifier for an entity that can be used to locate the entity in a model. Entity data in entity data column 1616 is the value of the mesh quality metric for a corresponding entity ID. In this illustrative example, the mesh quality metric is an in-radius.

A selection of an entity in entity section 1608 results in operations being displayed in operations section 1618. In this example, curve 132 has been selected in entities section 1608. In response to the selection, operations 1620 that can be performed on curve 132 and the resulting in-radius values from those operations are displayed in operations section 1618. As can be seen, some of operations 1620 may result in a less desirable in-radius value while some operations may result in a more desirable in-radius value. These operations are output by one or more machine learning models that predict the value for the in-radius. These values are output without needing to perform the suggested operations in operations section 1618 and generate meshes using the modified entity.

As depicted, a selection of one of operations 1620 in operations section 1618 results in that operation being performed on the selected entity. After the performance of the operation, the process can begin again with the same or different curve length in size field 1604 that is considered to be small. In some illustrative examples, a different value can be selected in size field 1604 or a different type of entity can be selected.

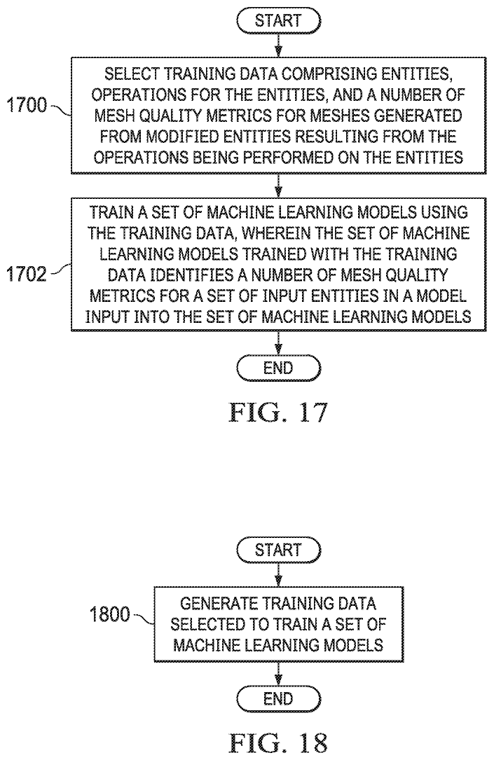

Turning next to FIG. 17, a flowchart of a process for training machine learning models is depicted in accordance with an illustrative embodiment. The process in FIG. 17 can be implemented in hardware, software, or both. When implemented in software, the process can take the form of program code that is run by one or more processor units located in one or more hardware devices in one or more computer systems. For example, the process can be implemented in model manager 206 in computer system 204 in FIG. 2.

The process begins by selecting training data comprising entities, operations for the entities, and a number of mesh quality metrics for meshes generated from modified entities resulting from the operations being performed on the entities (step 1700). The process trains a set of machine learning models using the training data, wherein the set of machine learning models trained with the training data identifies a number of mesh quality metrics for a set of input entities in a model input into the set of machine learning models (step 1702). The process terminates thereafter.

Turning now to FIG. 18, a flowchart of a process for training machine learning models is depicted in accordance with an illustrative embodiment. The step in this process can be performed as part of the process in FIG. 17 prior to performing step 1700 in FIG. 17. The process generates training data selected to train a set of machine learning models (step 1800). The process terminates thereafter.

For example, the selection of training data for use in training in step 1700 in FIG. 17 can be based on which machine learning models are being trained. .For example, the training data selected can include different training metrics depending on the type of machine learning model. For example, when the machine learning models being trained are classification machine learning models, classification metrics are used instead of regression metrics. When the machine learning models being trained are regression machine learning models, the training data containing regression metrics is selected for use in training the machine learning models.

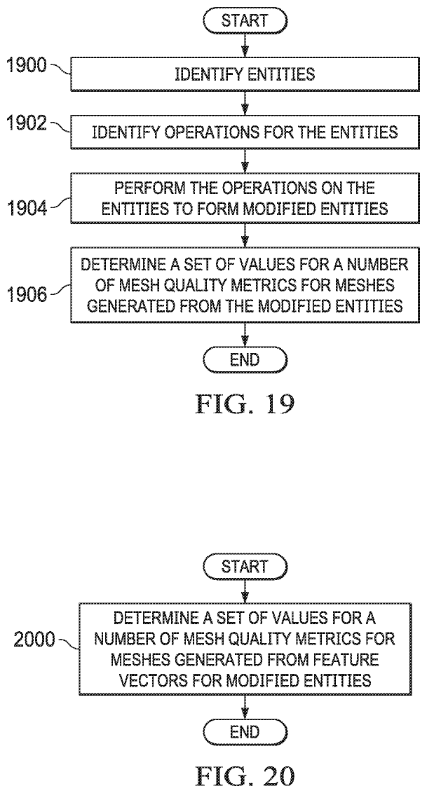

With reference next to FIG. 19, a flowchart of a process for generating training data is depicted in accordance with an illustrative embodiment. The process in this flowchart is an example of one manner in which step 1800 in FIG. 18 can be implemented.

The process begins by identifying entities (step 1900). In step 1900, the entities can be identified in one or more models. In these illustrative examples, the entities are geometric entities or components in computer-aided design (CAD) models.

The process identifies operations for the entities (step 1902). The process performs the operations on the entities to form modified entities (operation 1906).

The process determines a set of values for a number of mesh quality metrics for the meshes generated from the modified entities (step 1908). The process terminates thereafter.

Turning to FIG. 20, a flowchart of a process for determining mesh quality metrics for modified entities is depicted in accordance with an illustrative embodiment. The step in this flowchart are an example of one manner in which step 1908 in FIG. 19 can be implemented.

The process begins by determining a set of values for a number of mesh quality metrics for meshes generated from feature vectors for modified entities (step 2000). The process terminates thereafter.

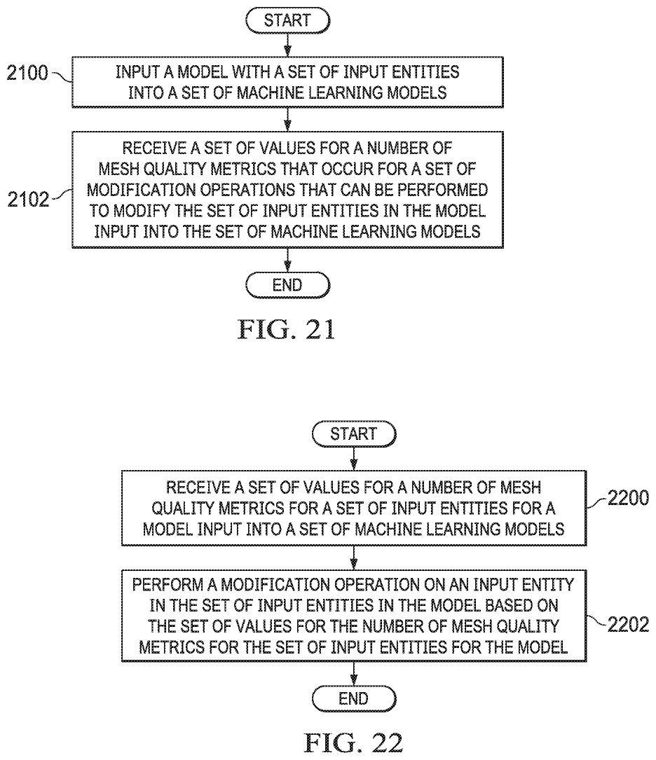

In FIG. 21, a flowchart of a process for obtaining mesh quality metrics for entities in a model is depicted in accordance with an illustrative embodiment. The process in FIG. 21 can be implemented in hardware, software, or both. When implemented in software, the process can take the form of program code that is run by one or more processor units located in one or more hardware devices in one or more computer systems. For example, the process can be implemented in model manager 206 in computer system 204 in FIG. 2.

The process begins by inputting a model with a set of input entities into a set of machine learning models (step 2100). The process receives a set of values for a number of mesh quality metrics that occur for a set of modification operations that can be performed to modify the set of input entities in the model input into the set of machine learning models (step 2102). The process terminates thereafter.

The set of values can be used in determining which, if any, modification operations should be performed on the input entities in the model. In the illustrative example, these values can be presented to the user or a computer-implemented process can determine which input entities may be modified, Further, these values can also be combined with other information for presentation to a user in a graphical user interface. For example, the values can be used to identify entities that are greater than some threshold for presentation. Further, the values can also be used to place the entities and operations for the entities in an order for review.

Turning now to FIG. 22, a flowchart of a process for performing a modification operation is depicted in accordance with an illustrative embodiment. The process in FIG. 22 can be implemented in hardware, software, or both. When implemented in software, the process can take the form of program code that is run by one or more processor units located in one or more hardware devices in one or more computer systems. For example, the process can be implemented in model manager 206 in computer system 204 in FIG. 2. This process can be initiated using values for mesh quality metrics obtained from machine learning models trained by model manager 206 using training data 220 in FIG. 2.

The process begins by receiving a set of values for a number of mesh quality metrics for a set of input entities for a model input into a set of machine learning models (step 2200).

The process performs a modification operation on an input entity in the set of input entities in the model based on the set of values for the number of mesh quality metrics for the set of input entities for the model (step 2202). The process terminates thereafter. Step 2202 can be performed a number of different ways. For example, at least one of user input or a policy can be used to perform the operation. User input, a policy, or both can be used to select the operation as part of performing the operation.

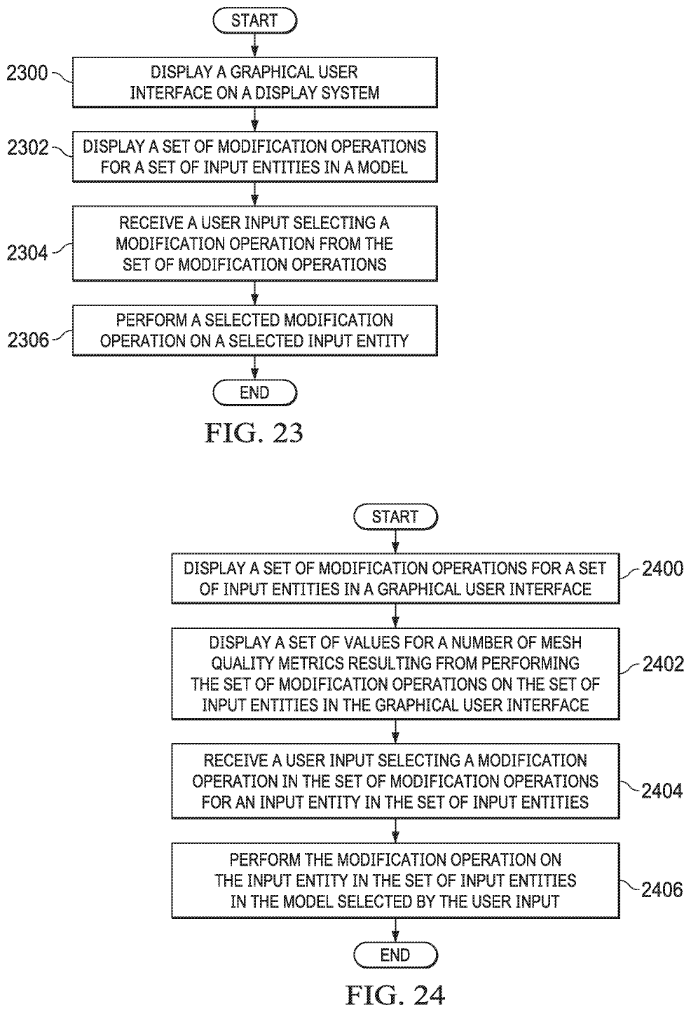

Turning now to FIG. 23, a flowchart of a process for performing a modification operation with user input is depicted in accordance with an illustrative embodiment. The process illustrated in FIG. 23 is an example of one manner in which step 2202 in FIG. 22 can be implemented. As depicted, this process can be implemented using user input received from a user operating a human machine interface, such as human machine interface 518 having display system 510 and input system 516 in FIG. 5.

The process begins by displaying a graphical user interface on a display system (step 2300). The process displays a set of modification operations for a set of input entities in a model (step 2302).

The process receives a user input selecting a modification operation from the set of modification operations (step 2304). In step 2304, the modification operation is associated with a particular input entity. As a result, the user input in step 2304 selects the modification operation for a particular input entity. The process performs a selected modification operation on a selected input entity (step 2306). The process terminates thereafter.

Turning now to FIG. 24, a flowchart of a process for performing a modification operation with user input is depicted in accordance with an illustrative embodiment. The process illustrated in FIG. 24 is another example of one manner in which step 2202 in FIG. 22 can be implemented. As depicted, this process can be implemented using user input received from a user operating a human machine interface, such as human machine interface 518 having display system 510 and input system 516 in FIG. 5.

The process begins by displaying a set of modification operations for a set of input entities in a graphical user interface (step 2400). The process displays a set of values for a number of mesh quality metrics resulting from performing the set of modification operations on the set of input entities in the graphical user interface (step 2402).

The process receives a user input selecting a modification operation in the set of modification operations for an input entity in the set of input entities (step 2404). The process performs the modification operation on the input entity in the set of input entities in the model selected by the user input (step 2406). The process terminates thereafter.

The processes in FIG. 23 and FIG. 24 can be repeated any number of times. Each time a modification operation is performed on an input entity, the values for mesh quality metrics can change as a result of the change in the geometry of the model for the object caused by modifying an input entity.

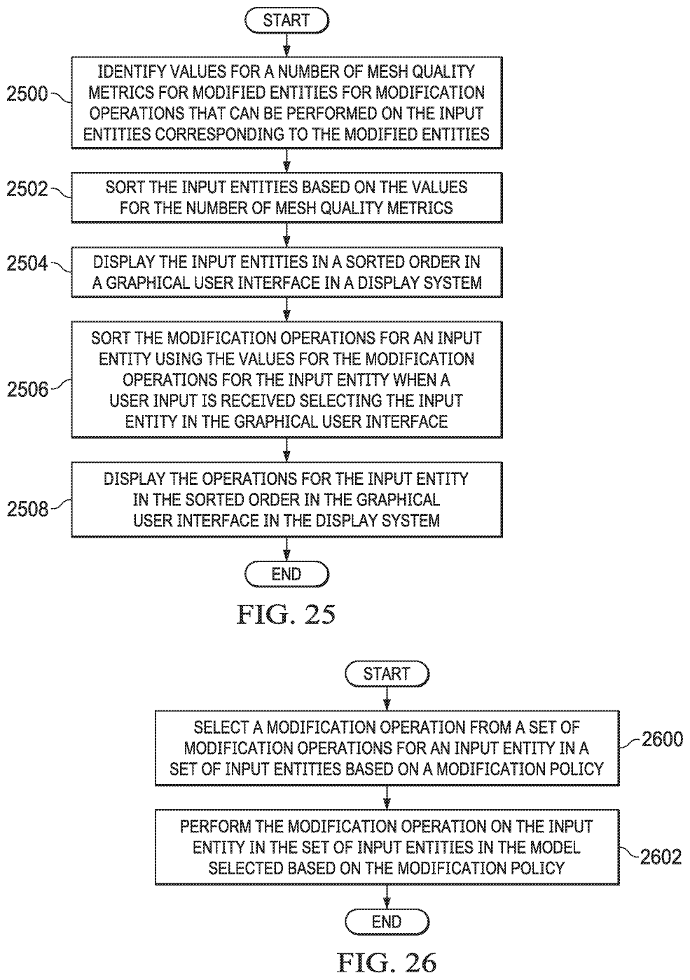

Turning now to FIG. 25, a flowchart of a process for displaying modification operations for a set of input entities on a graphical user interface is depicted in accordance with an illustrative embodiment. The process illustrated in FIG. 25 is an example of one manner in which step 2302 in FIG. 23 and step 2402 in FIG. 24 can be implemented.

The process begins by identifying values for a number of mesh quality metrics for modified entities for modification operations that can be performed on input entities corresponding to the modified entities (step 2500). In step 2500, the process only includes the modified entities for which meshes are generated when the input entities are modified using the modification operations. In other words, the input entities have already been classified as to whether the meshes can be generated from the modified entities resulting from modification of those input entities.

The process sorts the input entities based on the values for the number of mesh quality metrics (step 2502). In step 2502, the sorting can be based on the values obtained for modifying an input entity to form a modified entity without regard to a particular operation. In other words, these values output by the machine learning models indicate the mesh quality metrics that can be obtained from the modified entities obtained from performing the modification operations on the input entities. In this illustrative example, small entities (vertices, curves, and surfaces) are evaluated based on their “no_op” prediction of mesh quality. Entities are then sorted worst-to-best.

The process displays the input entities in a sorted order in a graphical user interface in a display system (step 2504). This display can also include displaying the values in association with the input entities.

The process sorts the modification operations for an input entity using the values for the modification operations for the input entity when a user input is received selecting the input entity in the graphical user interface (step 2506). The process displays the operations for the input entity in the sorted order in the graphical user interface in the display system (step 2508). The process terminates thereafter. In step 2508, the operations are sorted in order such as from highest-to-lowest values for the mesh quality metrics for the modification operations that can be performed on the selected input entity.

Turning now to FIG. 26, a flowchart of a process for performing a modification operation is depicted in accordance with an illustrative embodiment. The process illustrated in FIG. 26 is an example of one manner in which step 2202 in FIG. 22 can be implemented. As depicted, this process can be implemented without needing user input.

The process begins by selecting a modification operation from a set of modification operations for an input entity in a set of input entities based on a modification policy (step 2600). In step 2600. the process can select an input entity and then select a modification operation based on values for a number of mesh quality metrics output by a set of machine learning models.

For example, step 2600 can begin by selecting an input entity from input entities based on values for mesh quality metrics for modified entities resulting from modification operations that can be performed on input entities using the policy. The policy can support a threshold or other factors for selecting an entity for modification. For example, values over a certain threshold for a particular mesh quality metric can be used. In another example, particular types of entities may be given different thresholds to weigh preferences to modifying some types of input entities as compared to other types of input entities.

After selecting the input entity, a particular operation from a set of operations can be selected. The operations from which the selection is made are operations that can be performed on the input entity and are identified based on values for mesh quality metrics for meshes generated from modified input entities formed by performing different operations on the selected input entity.

The process performs the modification operation on the input entity in the set of input entities in the model selected based on the modification policy (step 2602). The process terminates thereafter.

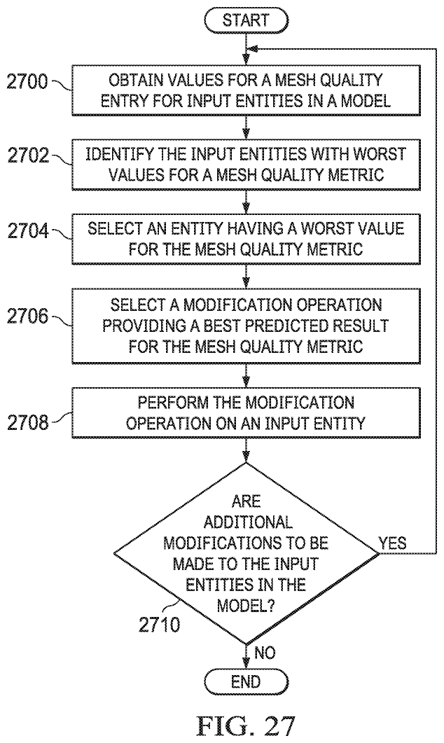

Turning next to FIG. 27, a process for performing a modification operation is depicted in accordance with an illustrative embodiment. The process illustrated in FIG. 27 is an example of one manner in which step 2202 in FIG. 22 can be implemented. As depicted, this process can be implemented without needing user input selecting an input entity or operation. This process can be initiated to allow a user to accept the best predicted modification operations without having to individually execute each modification operation. The process can successfully run and identify new entities for modification after performing a modification operation.

The process begins by obtaining values for a mesh quality entry for input entities in a model (step 2700). The process then identifies the input entities with worst values for a mesh quality metric (step 2702). In step 2702, the mesh quality metric may be, for example, a scaled Jacobin, an in-radius, or a deviation.

The process selects an entity having a worst value for a mesh quality metric (step 2704). The process then selects a modification operation providing a best predicted. result for the mesh quality metric (step 2706). The process performs the modification operation on an input entity (step 2708).

A determination is made as to whether additional modifications are to be made to the input entities in the model (step 2710). In a greedy approach, the determination can be to no longer make modifications if all predictions of no_op operations are greater than a user-defined threshold (successful termination) or predicted metrics for relevant operations would result in lower quality such that improvement does not occur.

If additional modifications are to be made, the process returns to step 2700. When the process returns step 2700, the model now includes one or more modified entities which results in changes to the mesh quality metric of interest. if additional modifications are not made, the process terminates. Thus, the steps in this flowchart use the operation providing the best results for the current state of the mesh. The process then is repeated based on the new state of the mesh after the operation has been performed.

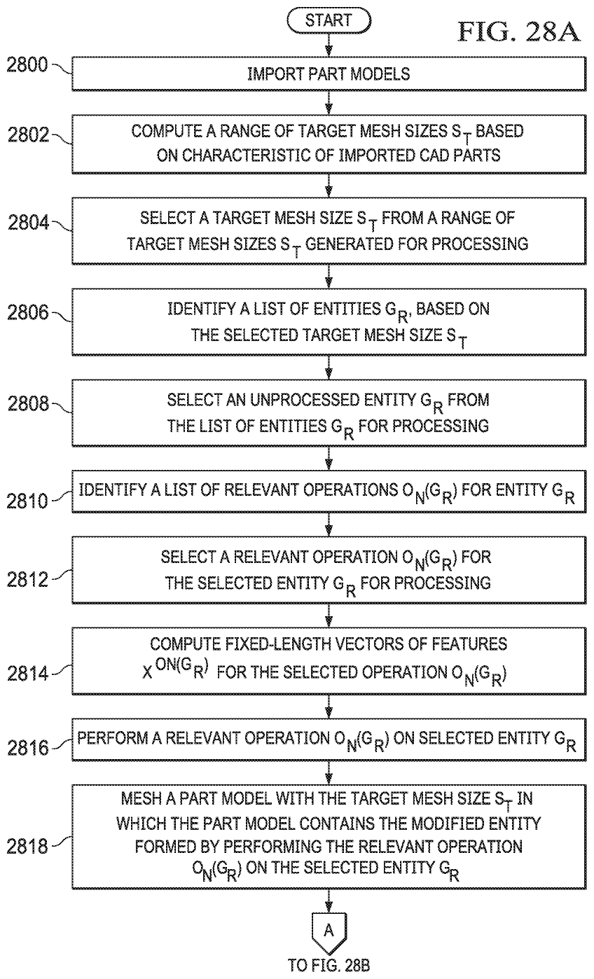

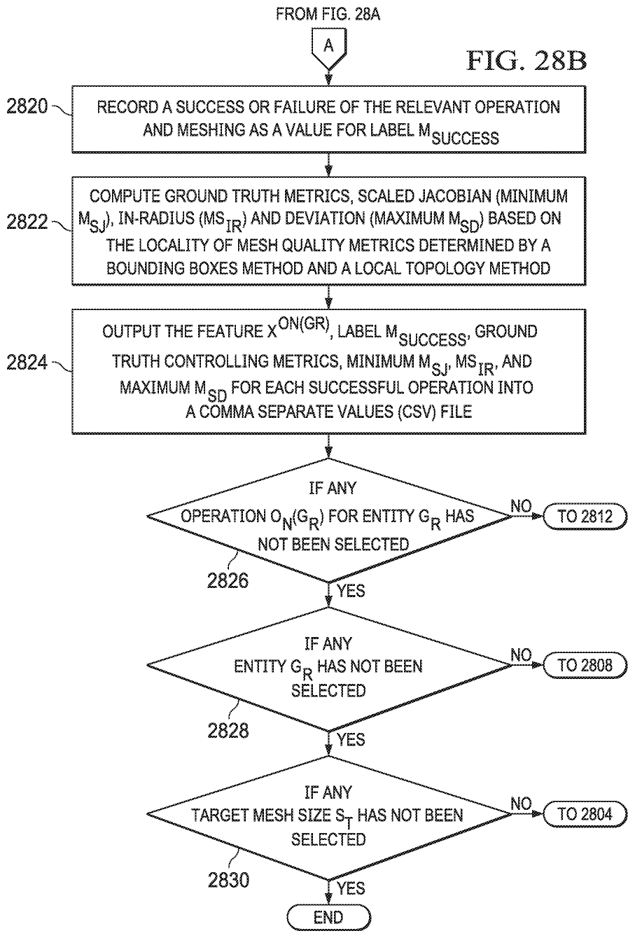

Turning next to FIGS. 28A-28B, a flowchart of a process for generating training data of a computer-aided design (CAD) defeaturing model is depicted in accordance with an illustrative embodiment. The process in FIGS. 28A-28B can be implemented in hardware, software, or both. When implemented in software, the process can take the form of program code that is run by one or more processor units located in one or more hardware devices in one or more computer systems. For example, the process can be implemented in model manager 206 in computer system 204 in FIG. 2.

The process begins by importing part models (step 2800). In step 2800, the part models are computer-aided design (CAD) part models that can be imported into a software tool kit that generates three-dimensional finite element meshes and geometry preparation. The software toolkit may include a mesh generating algorithm, for example, quadrilateral and triangular paving, two-dimensional and three-dimensional mapping, hex sweeping and multi-sweeping, tetrahedral meshing, and special purpose primitives. Further, the software toolkit may also include algorithms such as automatic scheme selection, interval matching, sweep grouping, and smoothing algorithms for controlling and automating of the meshing process.

The process computes a range of target mesh sizes S_{T} based on characteristics of imported CAD parts (step 2802). In step 2802, four target mesh sizes can be used.

A target mesh size can be defined by examining the geometric characteristics of the entities in the imported part models and assigning a heuristic size to the entities and their child entities with a factor. In one illustrative example, the factor may be a floating point number between 1.0 and 10.0, where 1.0 represents a fine size and 10.0 represents a coarse size.

The process selects a target mesh size S_{T} from the range of target mesh sizes S_{T} generated for processing (step 2804). The process identifies a list of entities G_{R} based on the selected target mesh size S_{T} (step 2806). Different target mesh sizes S_{T} are used because one mesh size may not be sharp or small while the same entity in another mesh size may be considered to be sharp or small. In step 2806, the list includes entities that are small entities or sharp vertices. In this illustrative example, sharp vertices are the tangent conditions where curves meet at zero degrees. In this example, small entities can be curves and surfaces that fall below a selected size. In the illustrative example, a small curve_length (L) can be derived from the target mesh size S_{T} where L=S_{T}/4. The same defaults described above for surfaces can be used (A=L^2 or HR=L) or for vertices, an angle at a vertex less than ten degrees. In the illustrative example, entities G_{R} such as sharp angles and curves and surfaces smaller than the predefined size are included in the list for processing to generate training data.

The process selects an unprocessed entity G_{R} from the list of entities G_{R} for processing (step 2808). The process identifies a list of relevant operations Oₙ(G_{R}) for entity G_{R} (step 2810). The relevant operations can be identified based on the entity type. For example, a vertex entity or a blunt tangency operation can be selected. However, a remove surface operation would not be relevant for a vertex. As another example, a curve could use a collapse curve operation, but could also use a composite operation for surfaces adjacent to the curve. A selection of relevant operations is returned from the software based on its entity type and its context within the geometry. In the illustrative example, the context of the geometry can indicate which entities in its immediate neighborhood are used to construct the relevant operations. Step 2810 can be performed in a number of different ways. For example, the relevant operations Oₙ(G_{R}) for entity G_{R} may include remove surface, tweak replace surface, composite surface, collapse curve, virtual collapse curve, tweak remove topology curve, tweak remove topology surface, blunt tangency, and remove cone. In another illustrative example, each operation Oₙ(G_{R}) can be trained on a separate machine learning model from other operations and trained with a number of entities.

The process selects a relevant operation Oₙ(G_{R}) from the list of operations for the selected entity G_{R} for processing (step 2812). The process computes fixed-length vectors of features X^{On(G}R⁾ for the selected operation Oₙ(G_{R}) (step 2814). In step 2814 the features can be expert features, geometric features, or both expert features and geometric features in this example. In the illustrative example, the computed vectors for features X^{On(G}R⁾ may be used as input for training a particular machine learning model in accordance with an illustrative example.

The process performs the relevant operation Oₙ(G_{R}) on selected entity G_{R} (step 2816). The process meshes a part model with the target mesh size S_{T} in which the part model contains the modified entity formed by performing the relevant operation Oₙ(G_{R}) on the selected entity G_{R} (step 2818). The relevant operation Oₙ(G_{R}) performed may fail when the geometric kernel is unable to resolve the topology for the given input or if the software is defective. The meshing of the imported part may fail when an operation succeeded, but modification of the selected entity G_{R} can affect the local topology such that the meshing process in the software is unable to proceed.

The process then records a success or failure of the relevant operation Oₙ(G_{R}) and meshing as a value for label M_{Success}(step 2820). The process computes ground truth metrics, scaled Jacobian (Minimum Mₛⱼ), in-radius (Mₛᵢᵣ), and deviation (Maximum M_{sd}) based on the locality of mesh quality metrics determined by a bounding boxes method and a local topology method (step 2822).

The process outputs the feature X^{On(GR)}, label M_{Success}, ground truth controlling metrics, Minimum Mₛⱼ, Mₛᵢᵣ, and Maximum M_{sd} for each successful operation into a comma separate values (CSV) file (step 2824).

The process determines whether any operation Oₙ(G_{R}) for an entity G_{R} has not been selected for processing (step 2826). When an operation Oₙ(G_{R}) for an entity G_{R} has not been selected, the process returns to step 2812. Otherwise, the process determines whether an entity G_{R} is present in the list of entities G_{R} has not been selected for processing (step 2828).

If an entity G_{R} is present that has not been selected for processing, the process returns to step 2808. Otherwise, the process determines whether target mesh size S_{T} within a range of target mesh sizes S_{T} has not been selected for processing (step 2830). If a target mesh size S_{T} within the range of target mesh sizes S_{T} has not been selected, the process returns to step 2804 as described above. Otherwise, the process terminates.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

For example, steps can be added to determine values for mesh quality metrics for meshes generated for entities prior to modifications. These values can be compared with values resulting from meshes generated for modified entities. Differences can be also output for use in evaluating in determining which entities may be modified when the model is to be used for simulations.

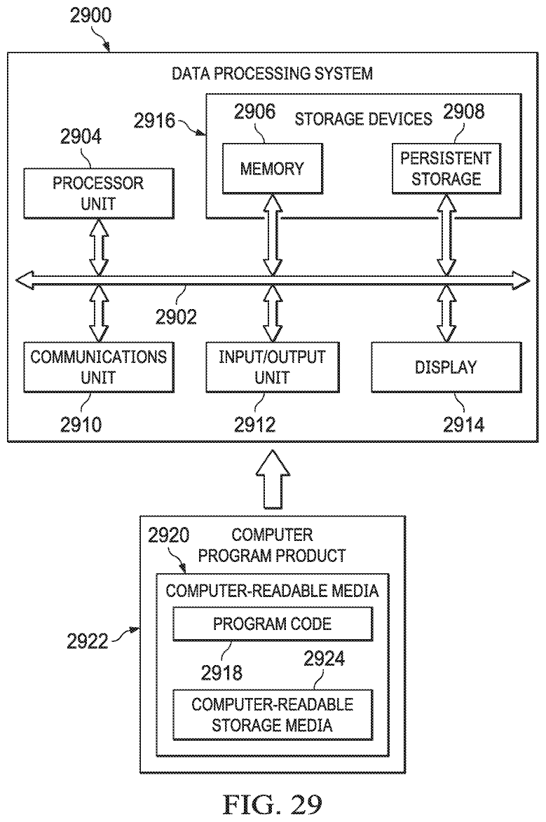

Turning now to FIG. 29, a block diagram of a data processing system is depicted in accordance with an illustrative embodiment. Data processing system 2900 can be used to implement server computer 104, server computer 106, and client devices 110 in FIG. 1. Data processing system 2900 can also be used to implement one or more data processing systems in computer system 204 in FIG. 2. In this illustrative example, data processing system 2900 includes communications framework 2902, which provides communications between processor unit 2904, memory 2906, persistent storage 2908, communications unit 2910, input/output (I/O) unit 2912, and display 2914. In this example, communications framework 2902 takes the form of a bus system.

Processor unit 2904 serves to execute instructions for software that can be loaded into memory 2906. Processor unit 2904 includes one or more processors. For example, processor unit 2904 can be selected from at least one of a multicore processor, a central processing unit (CPU), a graphics processing unit (GPU), a physics processing unit (PPU), a digital signal processor (DSP), a network processor, or some other suitable type of processor. Further, processor unit 2904 can may be implemented using one or more heterogeneous processor systems in which a main processor is present with secondary processors on a single chip. As another illustrative example, processor unit 2904 can be a symmetric multi-processor system containing multiple processors of the same type on a single chip.

Memory 2906 and persistent storage 2908 are examples of storage devices 2916. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 2916 may also be referred to as computer-readable storage devices in these illustrative examples. Memory 2906, in these examples, can be, for example, a random-access memory or any other suitable volatile or non-volatile storage device. Persistent storage 2908 may take various forms, depending on the particular implementation.

For example, persistent storage 2908 may contain one or more components or devices. For example, persistent storage 2908 can be a hard drive, a solid-state drive (SSD), a flash memory, a rewritable optical disk, a rewritable magnetic tape, or some combination of the above. The media used by persistent storage 2908 also can be removable. For example, a removable hard drive can be used for persistent storage 2908.

Communications unit 2910, in these illustrative examples, provides for communications with other data processing systems or devices. In these illustrative examples, communications unit 2910 is a network interface card.

Input/output unit 2912 allows for input and output of data with other devices that can be connected to data processing system 2900. For example, input/output unit 2912 may provide a connection for user input through at least one of a keyboard, a mouse, or some other suitable input device. Further, input/output unit 2912 may send output to a printer. Display 2914 provides a mechanism to display information to a user.

Instructions for at least one of the operating system, applications, or programs can be located in storage devices 2916, which are in communication with processor unit 2904 through communications framework 2902. The processes of the different embodiments can be performed by processor unit 2904 using computer-implemented instructions, which may be located in a memory, such as memory 2906.

These instructions are referred to as program code, computer usable program code, or computer-readable program code that can be read and executed by a processor in processor unit 2904. The program code in the different embodiments can be embodied on different physical or computer-readable storage media, such as memory 2906 or persistent storage 2908.

Program code 2918 is located in a functional form on computer-readable media 2920 that is selectively removable and can be loaded onto or transferred to data processing system 2900 for execution by processor unit 2904. Program code 2918 and computer-readable media 2920 form computer program product 2922 in these illustrative examples. In the illustrative example, computer-readable media 2920 is computer-readable storage media 2924.

In these illustrative examples, computer-readable storage media 2924 is a physical or tangible storage device used to store program code 2918 rather than a medium that propagates or transmits program code 2918.

Alternatively, program code 2918 can be transferred to data processing system 2900 using a computer-readable signal media. The computer-readable signal media can be, for example, a propagated data signal containing program code 2918. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, computer-readable media 2920″ can be singular or plural. For example, program code 2918 can be located in computer-readable media, 2920 in the form of a single storage device or system. In another example, program code 2918 can be located in computer-readable media 2920 that is distributed in multiple data processing systems. In other words, some instructions in program code 2918 can be located in one data processing system while other instructions in program code 2918 can be located in one data processing system. For example, a portion of program code 2918 can be located in computer-readable media 2920 in a server computer while another portion of program code 2918 can be located in computer-readable media 2920 located in a set of client computers.

The different components illustrated for data processing system 2900 are not meant to provide architectural limitations to the manner in which different embodiments can be implemented. In some illustrative examples, one or more of the components may be incorporated in or otherwise form a portion of, another component. For example, memory 2906, or portions thereof, may be incorporated in processor unit 2904 in some illustrative examples. The different illustrative embodiments can be implemented in a data processing system including components in addition to or in place of those illustrated for data processing system 2900. Other components shown in FIG. 29 can be varied from the illustrative examples shown. The different embodiments can be implemented using any hardware device or system capable of running program code 2918.

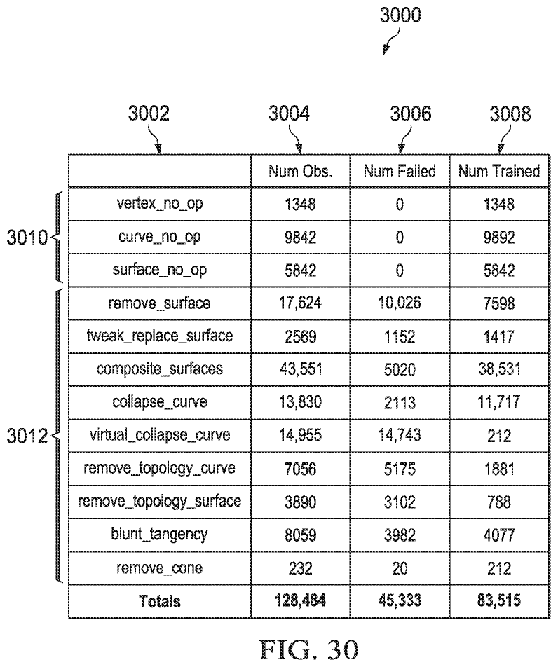

Turning next to FIG. 30, a table of results from performing operations on entities in computer-aided design (CAD) part models is depicted in accordance with an illustrative embodiment. In this illustrative example, table 3000 illustrates results from performing operations on 94 CAD parts. These results indicate the success and failure of generating meshes from modified CAD part models resulting from modifying entities in the models. In this example, each observation is based on the modification of one entity in a part model.

Training data is generated for each part using the process illustrated in FIGS. 28A-28B. In this example, the training data is generated for operations described in table 600 in FIG. 6. Additionally, the training data is generated for three “no-op” models. This data generation involves identifying small entities, where small is a function of a range of four target mesh sizes.

In this illustrative example, bad vertices are identified based on tangent or sharp angle conditions at the vertex. Relevant operations are selected for each small entity or bad vertex identified from a pre-defined set of operations for each entity type. Some culling of relevant operations was initially accomplished to reduce the number of operations that are needed to be trained. For example, the remove cone operation was trained only for entities where the underlying CAD kernel identified it as a conic surface type. Similarly, blunt tangency was only selected for vertices with adjacent curves forming an angle less than 10 degrees in the CAD parts. As a result, the number of observations varied for each operation type.

As depicted, column 3002 identifies operation types. Column 3004 identifies a number of observations made. Column 3006 identifies the number of operations in which meshes cannot be generated after modifying an entity or the classification procedure failed as recorded in step 2820 in FIGS. 28A-28B. Column 3008 indicates the number of operations modifying entities that were used for training regression machine learning models. In other words, an operation in column 3008 indicates that the training data for the operation was used in training a machine learning model and quality metrics were successfully generated. In other words, information about the operation, the entity, feature vectors (for the entity and operation), and mesh quality metrics for that operation is included in the training data for training machine learning models. In this illustrative example, the operations that were successful were used in training the regression machine learning models.

Operations 3010 are “no-op” operations not performed on particular types of entities that are a vertex, a curve, or a surface. Operations 3012 are operations from table 600 in FIG. 6.

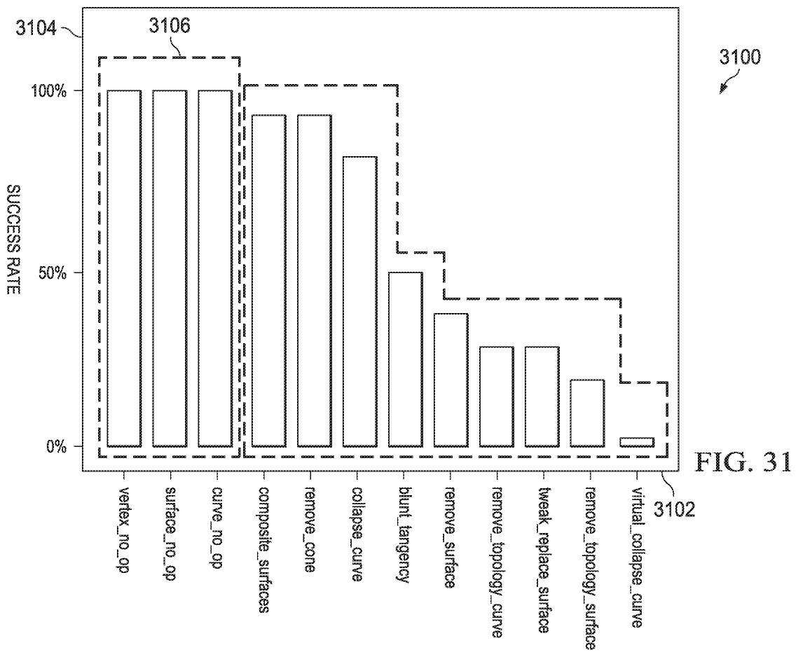

With reference now to FIG. 31, a bar graph illustrating success of operations is depicted in accordance with an illustrative embodiment. In this illustrative example, bar graph 3100 illustrates operations performed on entities during training data generation. Bar graph 3100 is based on data from table 3000 in FIG. 30.

In bar graph 3100, X-axis 3102 represents the type of operation and Y-axis 3104 represents the success rate. The data in this graph represents success rates during the generation of training data. The results are sorted based on success. Each bar indicates the percent of observations that succeeded by operation type. Each operation is performed on multiple types of entities in this example. Operations 3106 always succeed because these operations are “no-op” operations that act as placeholders.

From bar graph 3100, many failures were encountered during training data generation. The results in bar graph 3100 indicate some operations modifying entities resulted in failures in meshing or geometry modification more often than the operations succeeded for the local arrangement of curves and surfaces. These results suggest that failure prediction models may play a role in avoiding problems for a user. These results can be used to steer a user away from operations that are unlikely to succeed for a given entity within the geometry.

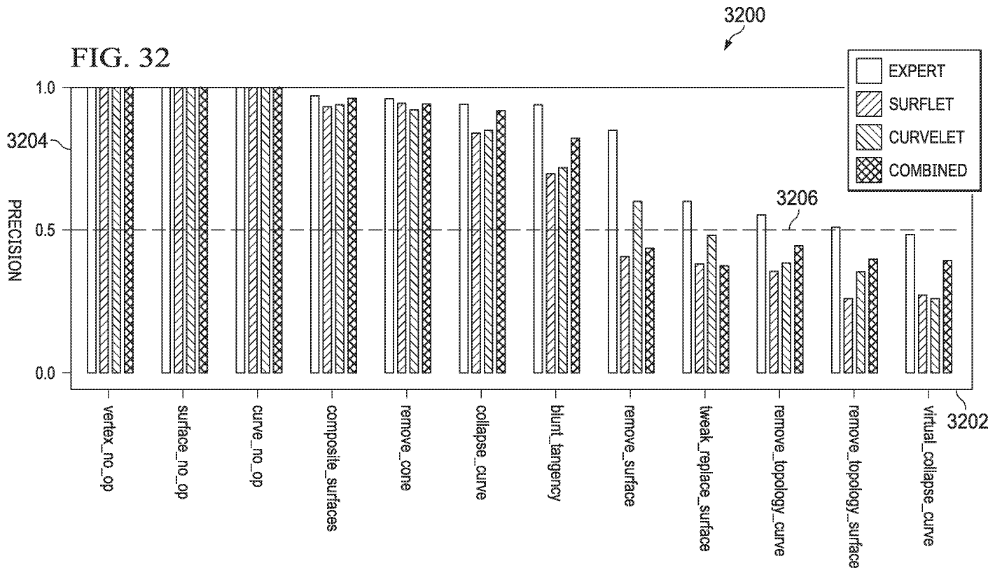

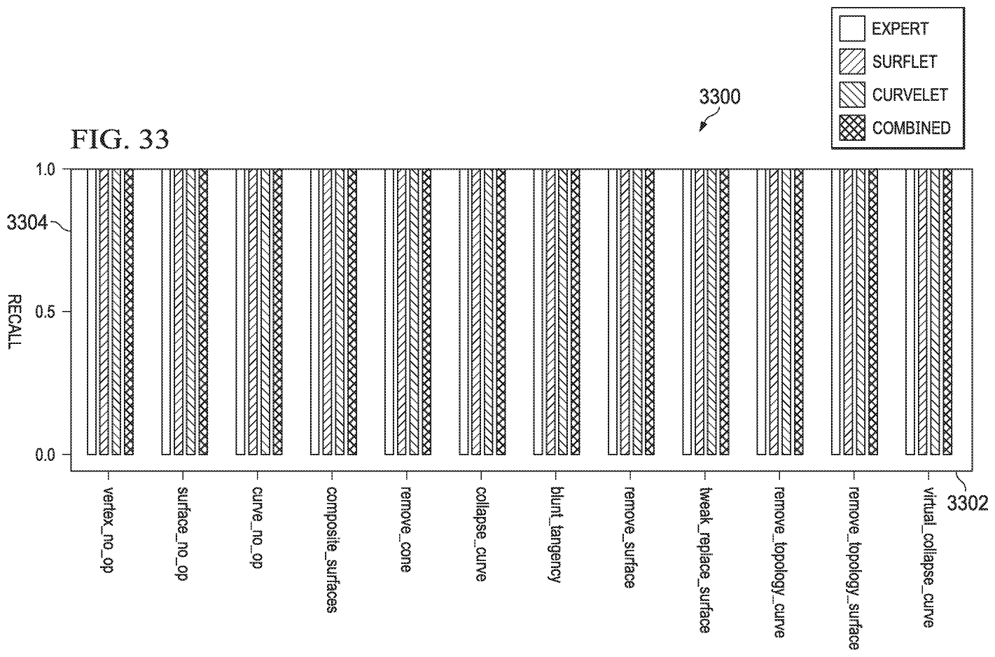

FIG. 32 and FIG. 33 illustrate scores for classification metrics for classification machine learning models trained using four sets of features. These graphs show results for models trained using four types of features. These features include expert, surflet, curvelet, and a combination of the three.

These classification metrics are output by machine learning models trained using training data generated based on the results from table 3000 in FIG. 30. In this illustrative example, the classification metrics include precision metrics and recall metrics. Precision is the percentage of operations predicted to fail that actually failed, while recall is the percentage of actual failures that were predicted to be failures. An ideal classification machine learning model balances high recall (avoiding false negatives) with high precision (avoiding false positives).

With reference to FIG. 32, a bar graph of precision scores for machine learning models is depicted in accordance with an illustrative embodiment. Bar graph 3200 illustrates precision scores for failure prediction models trained using four types of features with the results being grouped by operation. The results are sorted using scores from machine learning models trained using only expert features. In this illustrative example, X-axis 3202 is the operation and Y-axis 3204 is the precision. In the illustrative example, larger values indicate better results.

Machine learning models with a precision lower than 0.5 (50 percent) as shown by dashed line 3206 are wrong more often than right. In the illustrative example, the machine learning models with scores lower than 0.5 are excluded for use in classifying whether an entity can be modified by a particular operation and successfully matched after being modified. The machine learning models with precision scores above 0.5 achieved desired levels of accuracy such as nearly 1.0 (100 percent) in identifying actual failures in the training data.

Turning now to FIG. 33, a bar graph of recall scores for failure prediction models trained is depicted in accordance with an illustrative embodiment. Bar graph 3300 illustrates recall scores for failure prediction models trained using four types of features: expert, surflet, curvelet, and a combination of the three. In this depicted example, X-axis 3302 is the operation and Y-axis 3304 is the recall. In the illustrative example, larger values indicate better results. The results are grouped by operation and the results are sorted using scores from models trained using only expert features.

In the illustrative examples, bar graph 3200 in FIG. 32 and bar graph 3300 in FIG. 33 show that the machine learning models using expert features have a higher performance than those trained with the other features in every case, even models trained with a combination of all three feature types. Further, curvelet features produce slightly better results than surflets in many cases.

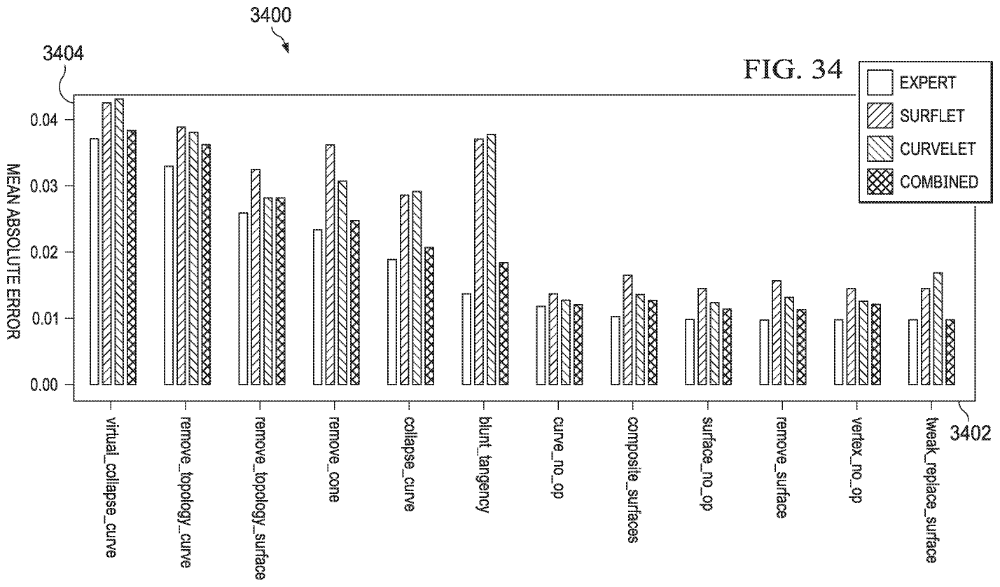

FIG. 34-FIG. 37 are bar graphs of mesh quality metrics by machine learning models. These mesh quality metrics are output by regression machine learning models trained using training data generated based on results in table 3000 in FIG. 30. These features include expert, surflet, curvelet, and a combination of the three. The bar graphs illustrate outputs predicting a scaled Jacobian, a scaled in-radius, and scaled deviation metrics, computed using bounding box and local topology regions. There is a total of six outputs for each model.

Because these metrics are continuous rather than categorical, the model results are reported using mean absolute error (MAE), the average of the absolute differences between the predicted and actual post-meshing quality metric values. Smaller MAE values indicate increased accuracy in the predictions.

With reference to FIG. 34, a bar graph of mean absolute error averaged across mesh quality metrics is depicted in accordance with an illustrative embodiment. In this illustrative example, bar graph 3400 depicts mesh quality metrics output by machine learning models trained using four types of features. In this depicted example, X-axis 3402 is the operation and Y-axis 3404 is the mean absolute error. As illustrated in bar graph 3400, the use of expert features for training results in better performance by machine learning models in outputting mesh quality metrics. For the operations trained, performance was determined only for operations predicted to succeed by the classification models.

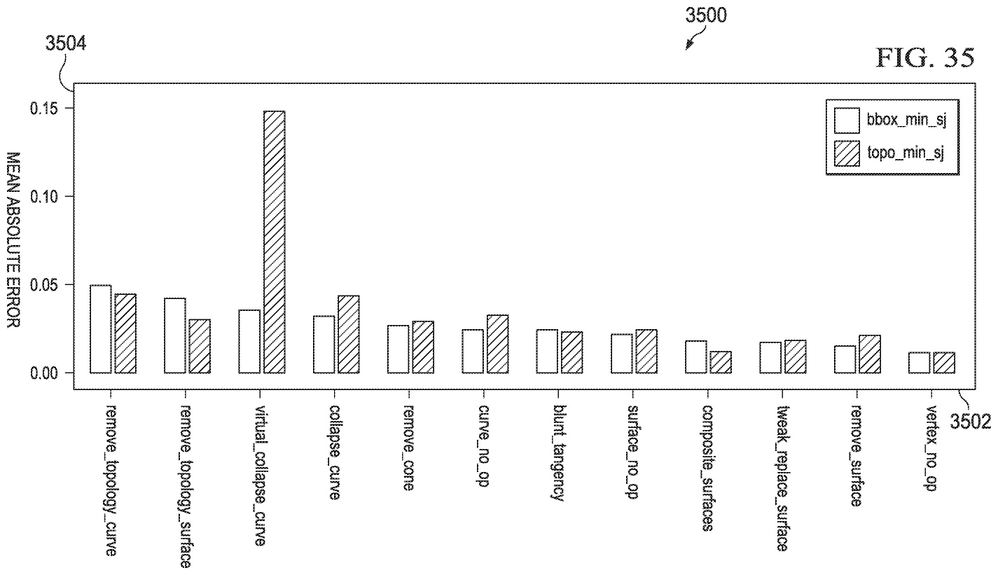

FIGS. 35-37 show values for individual metrics output by machine learning models using both bounding box and local topology in the training data. In FIG. 35, bar graph 3500 illustrates mesh quality metrics in the form of a scaled Jacobian depicted in accordance with an illustrative embodiment. Bar graph 3500 illustrates mean absolute error for the output of scaled Jacobian values by machine learning models for operations such as operations depicted in table 600 in FIG. 6. In this example, X-axis 3502 is the operation and Y-axis 3504 is the mean absolute error.

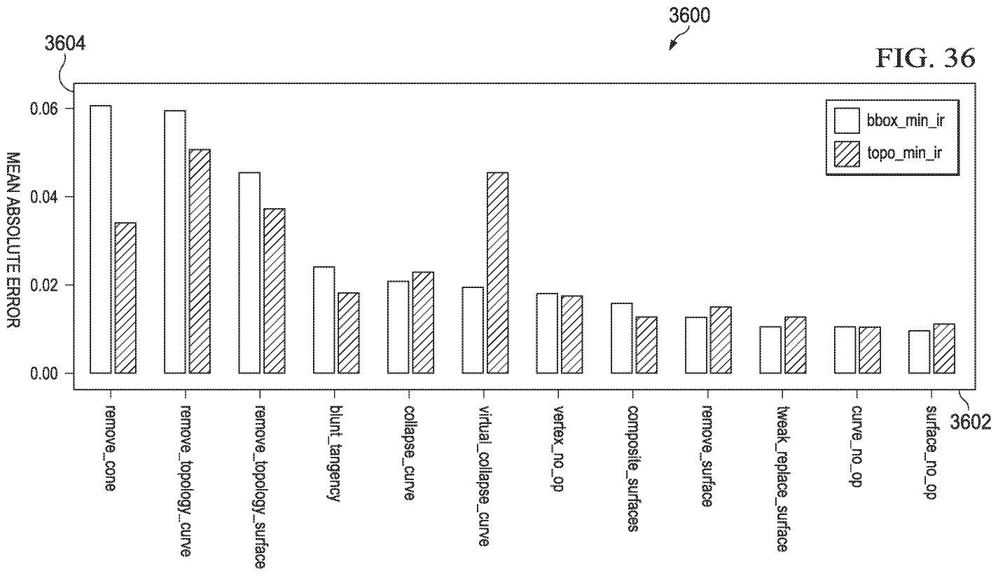

With reference next to FIG. 36, bar graph 3600 illustrates mesh quality metrics in a form of an in-radius depicted in accordance with an illustrative embodiment. Bar graph 3600 illustrates mean absolute error for the output of in-radius values by machine learning models for operations such as operations depicted in table 600 in FIG. 6. In this example, X-axis 3602 is the operation and Y-axis 3604 is the mean absolute error.

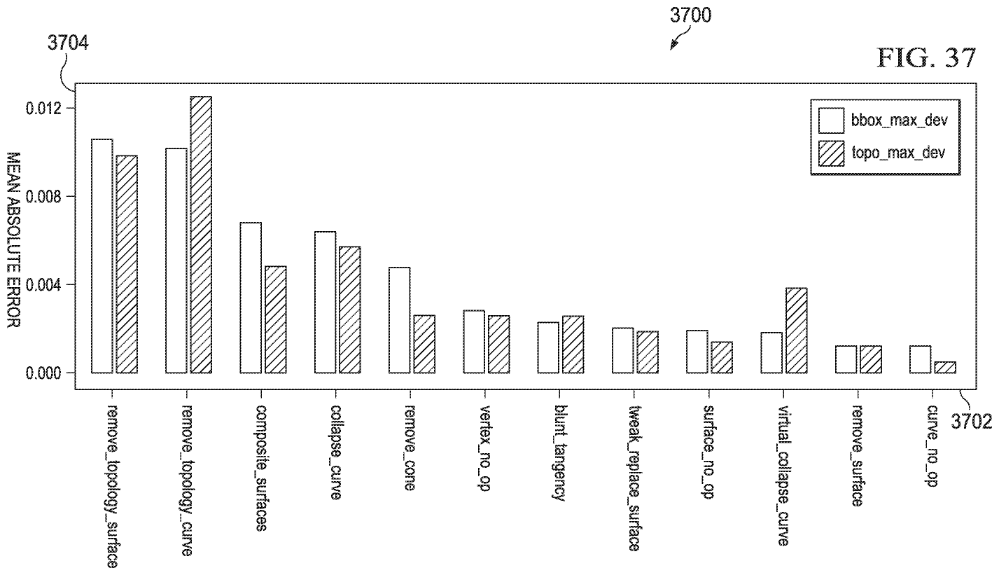

Turning to FIG. 37, bar graph 3700 illustrating mesh quality metrics in the form of a deviation is depicted in accordance with an illustrative embodiment. Bar graph 3700 illustrates mean absolute error for the output of deviation values by machine learning models for operations such as operations depicted in table 600 in FIG. 6. In this example, X-axis 3702 is the operation and Y-axis 3704 is the mean absolute error.

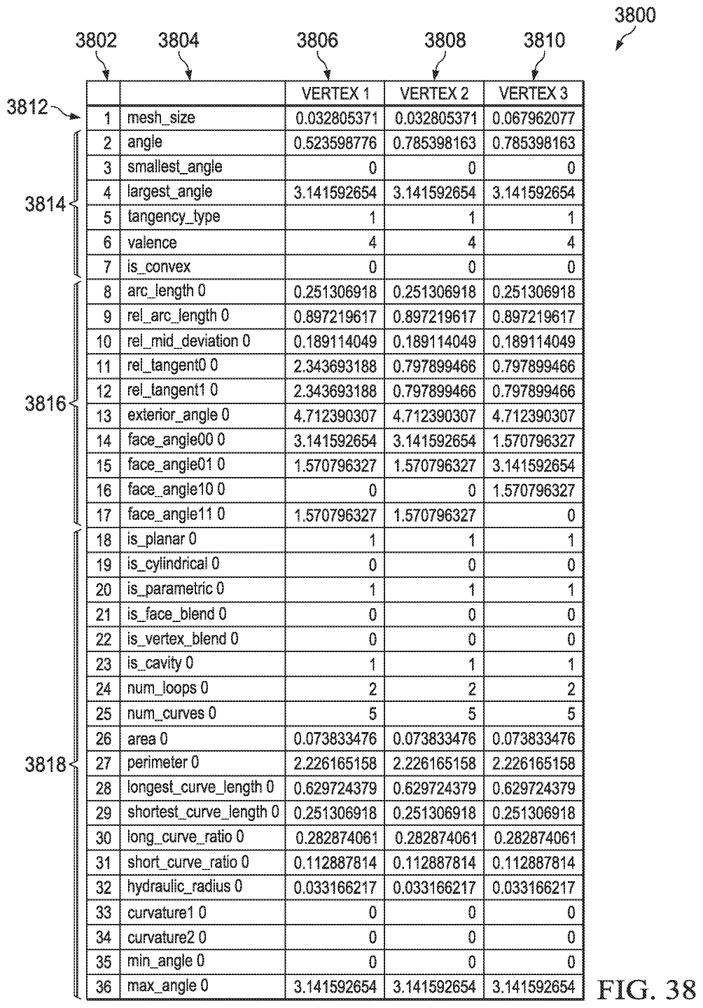

With reference now to FIG. 38, an illustration of table of feature vectors is depicted in accordance with an illustrative embodiment. In this illustrative example, table 3800 illustrates information used in feature vectors such as feature vectors 302 in FIG. 3. As depicted, index column 3802 in table 3800 provides an index to access information for a feature vector. Feature name column 3804 contains the name of features such as those in table 700 in FIG. 7.

Vertex 1 column 3806, vertex 2 column 3808. and vertex 3 column 3810 contain values for feature vectors for three vertexes. In other words, each column contains values for a feature vector for a vertex.

In this illustrative example, row 3812 in table 3800 identifies a mesh size for the vertex in vertex column 3806, vertex column 3808, and vertex column 3810. Rows 3814 are features of the vertex. Rows 3816 are features for adjacent curves to the vertex. Rows 3818 are features for adjacent surfaces at the vertex.

Thus, the illustrative embodiments of the present invention provide a computer-implemented method, computer system, and computer program product. In one illustrative example, a model modification system comprises a computer system and a model manager in the computer system. The model manager is configured to select training data comprising entities, operations for the entities, and a number of mesh quality metrics for meshes generated from modified entities resulting from the operations being performed on the entities. The model manager is configured to train a set of machine learning models using the training data, wherein the set of machine learning models trained with the training data identifies the number of mesh quality metrics for a set of input entities in a model input into the set of machine learning models.

With the machine learning technique employed by a model manager in the illustrative examples, accuracy in predicting mesh quality metrics based on local topology of an object can be determined without generating a mesh from the model. One or more illustrative examples enable machine learning models to output information about mesh quality metrics describing meshing outcomes from operations performed on entities without needing to generate meshes. Further, the information output by the machine learning models can be used to modify entities in a model of an object for use in forming simulations of the object. Further, one or more illustrative examples can define features for entities using at least one of expert features or geometric features.

Thus, the illustrative examples demonstrate steps for identifying operations that effectively modify features in a computer-aided design (CAD) model by training machine learning models to predict meshing outcomes for operations.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A model modification system comprising:
a computer system; and
a model manager in the computer system, wherein the model manager is configured to:
select training data comprising entities, operations for the entities, and a number of mesh quality metrics for meshes generated from modified entities resulting from the operations being performed on the entities; and
train a set of machine learning models using the training data, wherein the set of machine learning models trained with the training data identify the number of mesh quality metrics for a set of input entities in a model input into the set of machine learning models.

2. The model modification system of claim 1, wherein the model manager is configured to:
generate the training data selected to train the set of machine learning models.

3. The model modification system of claim 2, wherein in generating the training data used to train the set of machine learning models, the model manager is configured to:
identify the entities;
identify the operations for the entities;
perform the operations on the entities to form the modified entities; and
determine a set of values for the number of mesh quality metrics for the meshes generated from the modified entities.

4. The model modification system of claim 3, wherein in performing the operations on the entities to form the modified entities, the model manager is configured to:
determine feature vectors for the entities, wherein a feature vector describes an entity and a relationship of the entity with a set of adjacent entities; and
perform the operations on the entities to form modified entities, wherein in determining the set of values for the number of mesh quality metrics for the meshes generated from the modified entities, the model manager is configured to determine the set of values for the number of mesh quality metrics for the meshes generated from feature vectors for the modified entities.

5. The model modification system of claim 1, wherein the model manager is configured to:
input the model with the set of input entities into the set of machine learning models; and
receive a set of values for the number of mesh quality metrics that occur for a set of modification operations that can be performed to modify the set of input entities in the model input into the set of machine learning models.

6. The model modification system of claim 5, wherein the model manager is configured to:
perform a modification operation on an input entity in the set of input entities in the model based on the set of values for the number of mesh quality metrics for the set of input entities for the model.

7. The model modification system of claim 6, wherein in performing the modification operation on the input entity in the set of input entities in the model based on the set of values for the number of mesh quality metrics for the set of input entities for the model, the model manager is configured to:
display a set of modification operations for the set of input entities in a graphical user interface;
display the set of values for the number of mesh quality metrics resulting from performing the set of modification operations on the set of input entities in the graphical user interface;
receive a user input selecting the modification operation in the set of modification operations for an input entity in the set of input entities; and
perform the modification operation on the input entity in the set of input entities in the model selected by the user input.

8. The model modification system of claim 6, wherein in performing the modification operation on the input entity in the set of input entities in the model based on the set of values for the number of mesh quality metrics for the set of input entities for the model, the model manager is configured to:
select the modification operation from the set of modification operations for an input entity in the set of input entities based a modification policy; and
perform the modification operation on the input entity in the set of input entities in the model selected based on applying the modification policy.

9. The model modification system of claim 6, wherein the model manager is configured to:
display a graphical user interface on a display system;
display the modification operations for the set of input entities in the model; and
receive a user input selecting the modification operation from the set of modification operations.

10. The model modification system of claim 1, wherein the meshes used to determine the mesh quality metrics are described using at least one of a bounding box or a topology.

11. The model modification system of claim 1, wherein the mesh quality metrics is selected from at least one of a success of an operation, a scaled Jacobian, an in-radius, and a deviation.

12. The model modification system of claim 1, wherein an entity in the entities is described by a set of feature vectors for a set of features.

13. The model modification system of claim 12, wherein the set of features is selected from at least one of a curve length, a surface area, an angle at a vertex, an angle at a curve, a valence at the vertex, a number of loops, or a hydraulic radius.

14. The model modification system of claim 1, wherein operations are selected from at least one of remove an entity, combine entities, modify the entity, remove an entity replacement, remove surface, tweak replace surface, composite surfaces, collapse curve, virtual collapse curve, tweak remove topology curve, tweak remove topology surface, blunt tangency, or remove cone.

15. A model modification system comprising:
a computer system; and
a set of machine learning models in the computer system, wherein the set of machine learning models were trained using training data comprising entities, operations for the entities, and quality metrics for modified entities after the operations are performed on the entities, wherein the set of machine learning models identify a number of quality metrics for a set of input entities input to the set of machine learning models.

16. A method for modifying a model, the method comprising:
selecting, by a computer system, training data comprising entities, operations for the entities, and a number of mesh quality metrics for meshes generated from modified entities resulting from the operations being performed on the entities; and
training, by the computer system, a set of machine learning models using the training data, wherein the set of machine learning models trained with the training data identify number of mesh quality metrics for a set of input entities in a model input into the set of machine learning models.

17. The method of claim 16 further comprising:
generating, by the computer system, the training data selected to train the set of machine learning models.

18. The method of claim 17, wherein generating the training data used to train the set of machine learning models comprises:
identifying, by the computer system, the entities;
identifying, by the computer system, the operations for the entities;
performing, by the computer system, the operations on the entities to form the modified entities; and
determining, by the computer system, a set of values for the number of mesh quality metrics for the meshes generated from the modified entities.

19. The method of claim 18, wherein performing the operations on the entities to form the modified entities comprises:
determining, by the computer system, feature vectors for the entities, wherein a feature vector describes an entity and a relationship of the entity with a set of adjacent entities; and
performing, by the computer system, the operations on the entities to form modified entities;
wherein determining, by the computer system, the set of values for the number of mesh quality metrics for the meshes generated from the modified entities comprises:
determining, by the computer system, the set of values for the number of mesh quality metrics for the meshes generated from feature vectors for the modified entities.

20. The method of claim 16 further comprising:
inputting, by the computer system, the model with the set of input entities into the set of machine learning models; and
receiving, by the computer system, a set of values for the number of mesh quality metrics that occur for a set of modification operations that can be performed to modify the set of input entities in the model input into the set of machine learning models.

21. The method of claim 20 further comprising:
performing, by the computer system, a modification operation on an input entity in the set of input entities in the model based on the set of values for the number of mesh quality metrics for the set of input entities for the model.

22. The method of claim 21, wherein performing the modification operation on the input entity in the set of input entities in the model based on the set of values for the number of mesh quality metrics for the set of input entities for the model comprises:
displaying, by the computer system, a set of modification operations for the set of input entities in a graphical user interface;
displaying, by the computer system, the set of values for the number of mesh quality metrics resulting from performing the set of modification operations on the set of input entities in the graphical user interface;
receiving, by the computer system, a user input selecting the modification operation in the set of modification operations for an input entity in the set of input entities; and
performing, by the computer system, the modification operation on the input entity in the set of input entities in the model selected by the user input.

23. The method of claim 21, wherein performing the modification operation on the input entity in the set of input entities in the model based on the set of values for the number of mesh quality metrics for the set of input entities for the model comprises:
selecting, by the computer system, the modification operation from the set of modification operations for an input entity in the set of input entities based a modification policy; and
performing, by the computer system, the modification operation on the input entity in the set of input entities in the model selected based on the modification policy.

24. The method of claim 21 further comprising:
displaying, by the computer system, a graphical user interface on a display system;
displaying, by the computer system, the modification operations for the set of input entities in the model; and
receiving, by the computer system, a user input selecting the modification operation from the set of modification operations.

25. The method of claim 16, wherein the meshes used to determine the mesh quality metrics are described using at least one of a bounding box or a topology.

26. The method of claim 16, wherein the mesh quality metrics is selected from at least one of a success of an operation, a scaled Jacobian, an in-radius, and a deviation.

27. The method of claim 16, wherein an entity in the entities is describe by a set of feature vectors for a set of features.

28. The method of claim 27, wherein the set of features is are selected from at least one of a curve length, a surface area, an angle at a vertex, an angle at a curve, a valence at the vertex, a number of loops, or a hydraulic radius.

29. The method of claim 16, wherein operations are selected from at least one of remove an entity, combine entities, modify the entity, remove an entity replacement, remove surface, tweak replace surface, composite surfaces, collapse curve, virtual collapse curve, tweak remove topology curve, tweak remove topology surface, blunt tangency, or remove cone.

30. A computer program product for modifying a model, the computer program product comprising:
a computer-readable storage media;
first program code, stored on the computer-readable storage media, executable by a computer system to cause the computer system to select training data comprising entities, operations for the entities, and a number of mesh quality metrics for meshes generated from modified entities resulting from the operations being performed on the entities; and
second program code, stored on the computer-readable storage media, executable by the computer system to cause the computer system to train a set of machine learning models using the training data, wherein the set of machine learning models trained with the training data identify the number of mesh quality metrics for a set of input entities in a model input into the set of machine learning models.

31. The computer program product of claim 30 further comprising:
third program code, stored on the computer-readable storage media, executable by the computer system to cause the computer system to generate the training data used to train the set of machine learning models.

32. The computer program product of claim 31, the third program code comprises:
program code, stored on the computer-readable storage media, executable by the computer system to cause the computer system to identify the entities;
program code, stored on the computer-readable storage media, executable by the computer system to cause the computer system to identify the operations for the entities;
program code, stored on the computer-readable storage media, executable by the computer system to cause the computer system to perform the operations on the entities to form the modified entities; and
program code, stored on the computer-readable storage media, executable by the computer system to cause the computer system to determine a set of values for the number of mesh quality metrics for the meshes generated from the modified entities.
